(19) United States
(12) Patent Application Publication
(10) Pub. No.: US 2013/0287439 A1
(43) Pub. Date: Oct. 31, 2013

(54) CLEANING UNIT, PROCESS CARTRIDGE, AND ELECTROPHOTOGRAPHIC IMAGE FORMING APPARATUS

(71) Applicant: CANON KABUSHIKI KAISHA, Tokyo (JP)

(72) Inventors: Kazuo Chadani, Suntou-gun (JP); Akihiro Fujiwara, Mishima-shi (JP); Susumu Nittani, Suntou-gun (JP); Masato Tanabe, Susono-shi (JP); Hideki Kakuta, Suntou-gun (JP); Keisuke Nomura, Suntou-gun (JP)

(73) Assignee: CANON KABUSHIKI KAISHA, Tokyo (JP)

(21) Appl. No.: 13/862,743

(22) Filed: Apr. 15, 2013

(30) Foreign Application Priority Data
Apr. 26, 2012 (JP) 2012-101857

(51) Int. Cl. G03G 21/00

(52) U.S. Cl. CPC G03G 21/007
USPC 399/123; 399/351

(57) ABSTRACT

A cleaning unit including: frame abutment portions each including a first abutment portion and a second abutment portion; support portions each including a first support portion which abuts against the first abutment portion, and a second support portion which abuts against the second abutment portion so as to support a cleaning member in a pivotable manner about the frame abutment portions as a pivot axis; and an urging member configured to urge the cleaning member in a direction in which an elastic member is brought into contact with a photosensitive drum by pivoting the cleaning member.

### BACKGROUND OF THE INVENTION

1. Field of the Invention

The present invention relates to a cleaning unit and a process cartridge which are used in an electrophotographic image forming apparatus, and to the electrophotographic image forming apparatus.

Herein, an electrophotographic image forming apparatus refers to an apparatus configured to form an image on a recording material (recording medium) by an electrophotographic method (electrophotographic image forming process).

Examples of the electrophotographic image forming apparatus include a printer (laser beam printer, light emitting diode (LED) printer, etc.), a copying machine, a facsimile apparatus, a word processor, and a multifunction peripheral (multifunction printer) of those apparatus.

2. Description of the Related Art

In the electrophotographic image forming apparatus (hereinafter also simply referred to as “image forming apparatus”), an electrophotographic photosensitive member as an image bearing member, which generally has a drum shape, in other words, a photosensitive drum is uniformly charged. Then, the charged photosensitive drum is subjected to selective exposure so as to form an electrostatic latent image (electrostatic image) on the photosensitive drum. Next, the electrostatic latent image formed on the photosensitive drum is developed into a toner image with toner as developer. After that, the toner image formed on the photosensitive drum is transferred onto a recording material such as a recording sheet of paper and a plastic sheet, and heat and pressure are applied to the toner image transferred onto the recording material so as to fix the toner image to the recording material. In this way, image recording is performed.

In general, such an image forming apparatus requires toner supply and maintenance of various processing units. In order to facilitate the toner supply and the maintenance, there has been practically used a process cartridge obtained by integrating the photosensitive drum, a charging unit, a developing unit, and a cleaning unit into a frame(s) of a cartridge, which is removably mounted to a main body of the image forming apparatus.

Image forming apparatus of such a process cartridge type enable a user himself/herself to perform maintenance of the image forming apparatus, and hence operability can be markedly enhanced. As a result, an image forming apparatus excellent in usability can be provided. For this reason, the image forming apparatus of the process cartridge type have been widely used.

As described above, a cleaning member as the cleaning unit configured to remove toner (residual toner) remaining on a surface of the photosensitive drum after the transfer step from the photosensitive drum is provided in the process cartridge. In some cases, it is desired that the cleaning member which abuts against the photosensitive drum be supported in a pivotable manner.

In a cleaning unit disclosed in Japanese Patent Application Laid-Open No. H06-161328, the cleaning member is supported in a pivotable manner with respect to the frame. Specifically, in the cleaning unit disclosed in Japanese Patent Application Laid-Open No. H06-161328, a support member for a cleaning blade is supported in a pivotable manner through pins by the frame, and the cleaning blade is pressed against a photosensitive member by springs.

However, the structure as described above, in which the cleaning member is supported in a pivotable manner through, for example, the pins, has problems in that a larger number of components and higher cost thereof are required, and the structure is liable to be complicated.

### SUMMARY OF THE INVENTION

The present invention provides a cleaning unit, a process cartridge, and an electrophotographic image forming apparatus which enable a cleaning member to be supported in a pivotable manner with a simple structure such as a frame without use of separate members such as pins, to thereby achieve reduction in manufacturing cost and to facilitate assembly.

A cleaning unit according to an embodiment of the present invention, includes: a rotatable photosensitive drum; a cleaning member configured to remove toner from the photosensitive drum; and a frame configured to support the photosensitive drum and the cleaning member. The cleaning member includes: an elastic member which abuts against the photosensitive drum; and a support member configured to support the elastic member. The support member has frame abutment portions which abut against the frame at both end portions of the support member in a direction along a direction of a rotation axis of the photosensitive drum, respectively. Each of the frame abutment portions has: a first abutment portion formed by a surface extending in one direction; and a second abutment portion formed by a surface extending in another direction intersecting with the one direction, the first abutment portion being directed to a side opposite to a side of the photosensitive drum with respect to a first axis extending from a corresponding one of the frame abutment portions to the elastic member as viewed in the direction of the rotation axis of the photosensitive drum, the second abutment portion being directed to a side opposite to a side of the elastic member with respect to a second axis substantially orthogonal to the first axis. The frame includes cleaning member support portions which abut against the frame abutment portions at both the end portions of the support member, respectively. Each of the cleaning member support portions has: a first support portion which abuts against the first abutment portion; and a second support portion which abuts against the second abutment portion, the cleaning member support portions supporting the cleaning member in a pivotable manner about the frame abutment portions as a pivot axis. The cleaning unit further includes an urging member configured to urge the cleaning member in a direction in which the elastic member is brought into contact with the photosensitive drum by pivoting the cleaning member about the frame abutment portions as the pivot axes.

A process cartridge according to another embodiment of the present invention, includes the cleaning unit as mentioned above. The process cartridge is removably mounted to a main body of an electrophotographic image forming apparatus. The electrophotographic image forming apparatus transfers a toner image, which is formed on the photosensitive drum, onto a recording material, fixes the toner image to the recording material, and outputs the recording material.

An electrophotographic image forming apparatus according to still another embodiment of the present invention, includes the process cartridge, as mentioned above, which is removably mounted to the electrophotographic image forming apparatus which transfers a toner image, which is formed on the photosensitive drum, onto a recording material, fixes the toner image to the recording material, and outputs the recording material.

Further features of the present invention will become apparent from the following description of exemplary embodiments with reference to the attached drawings.

### BRIEF DESCRIPTION OF THE DRAWINGS

FIG. 1 is a sectional view of an electrophotographic image forming apparatus according to an embodiment of the present invention.

FIG. 2 is a sectional view of a process cartridge according to the embodiment of the present invention.

FIG. 3 is a perspective view of the process cartridge according to the embodiment of the present invention.

FIG. 4 is a perspective view of a developing unit according to the embodiment of the present invention.

FIG. 5 is a perspective view of a cleaning frame according to the embodiment of the present invention.

FIG. 6 is a perspective view of a cleaning member according to the embodiment of the present invention.

FIG. 7 is a sectional view of a cleaning unit according to the embodiment of the present invention.

FIG. 8 is a partial sectional view of the cleaning unit according to the embodiment of the present invention, for illustrating a force exerted on the cleaning member.

FIG. 9 is a partial sectional view of the cleaning unit according to the embodiment of the present invention.

FIG. 10 is a partial sectional view of the cleaning unit according to the embodiment of the present invention.

FIG. 11 is a sectional view of the cleaning unit according to the embodiment of the present invention.

FIG. 12 is a partially exploded perspective view of the cleaning unit according to the embodiment of the present invention.

FIG. 13 is a partially exploded perspective view of the cleaning unit according to the embodiment of the present invention.

FIG. 14 is a partial perspective view of the cleaning frame according to the embodiment of the present invention, for illustrating another configuration example of a support portion.

FIG. 15 is a partial sectional view of the cleaning unit according to the embodiment of the present invention, for illustrating the configuration example of the support portion.

FIGS. 16A and 16B are a front view and a sectional view, respectively, for illustrating still another configuration example of the support portion according to the embodiment of the present invention.

FIG. 17 is a partially exploded perspective view of a cleaning unit according to another embodiment of the present invention.

FIG. 18 is a perspective view of the cleaning unit according to another embodiment of the present invention.

FIG. 19 is an exploded perspective view of the cleaning unit according to another embodiment of the present invention.

FIG. 20 is a partial sectional view of the cleaning unit according to another embodiment of the present invention.

FIG. 21 is a partial sectional view of the cleaning unit according to another embodiment of the present invention.

FIG. 22 is a partially exploded perspective view of a cleaning unit according to still another embodiment of the present invention.

FIG. 23 is an exploded perspective view of the cleaning unit according to the still another embodiment of the present invention.

FIG. 24 is a partial sectional view of the cleaning unit according to the still another embodiment of the present invention.

FIG. 25 is a partial sectional view of the cleaning unit according to the still another embodiment of the present invention.

FIGS. 26A and 26B are perspective views of a cleaning unit according to yet another embodiment of the present invention.

FIG. 27A is a perspective view of a cleaning frame according to the yet another embodiment of the present invention.

FIG. 27B is a partially enlarged perspective view of an encircled portion XXVIIB in FIG. 27A.

FIG. 27C is a partially enlarged perspective view of a positioning portion of FIG. 27B as viewed in another direction.

FIG. 28A is another perspective view of the cleaning frame and a cleaning member according to the yet another embodiment of the present invention.

FIG. 28B is a partially enlarged perspective view of an encircled portion XXVIIIB in FIG. 28A.

FIG. 28C is a partially enlarged perspective view of a positioned portion of FIG. 28B as viewed in another direction.

FIG. 29 is a partial sectional view of the cleaning unit according to the yet another embodiment of the present invention, for illustrating a positioning region of a positioning portion.

FIG. 30 is a main-part schematic view of the cleaning frame and the cleaning member according to the yet another embodiment of the present invention, for illustrating another arrangement example of a positioned surface.

FIGS. 31A and 31B are schematic views of a substantial part of a cleaning frame and a cleaning member according to another modification of the present invention.

### DESCRIPTION OF THE EMBODIMENTS

In the following, a cleaning unit, a process cartridge, and an electrophotographic image forming apparatus according to the present invention will be described in further detail with reference to the drawings.

### First Embodiment

1. Overall Structure of Image Forming Apparatus

First, an overall structure of an electrophotographic image forming apparatus (image forming apparatus) 100 according to an embodiment of the present invention will be described.

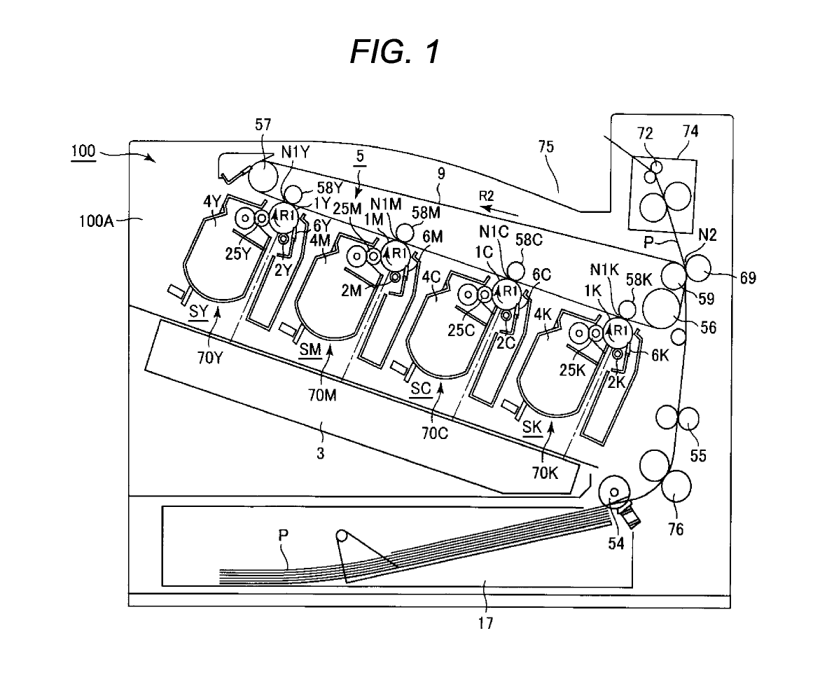

FIG. 1 is a sectional view illustrating the overall structure of the image forming apparatus 100 according to the embodiment. The image forming apparatus 100 includes, as a plurality of image forming portions, a first image forming portion SY configured to form an image having a color of yellow (Y), a second image forming portion SM configured to form an image having a color of magenta (M), a third image forming portion SC configured to form an image having a color of cyan (C), and a fourth image forming portion SK configured to form an image having a color of black (K).

Note that, in the embodiment, the structures and operations of the first to fourth image forming portions are substantially the same except that a color of an image to be formed is different for each image forming portion. Accordingly, in the following, in the case where the respective image forming portions are specially not required to be distinguished from each other, the suffixes of respective symbols Y, M, C, and K, which indicate which element of the image forming portion is provided, are omitted and collectively described.

The image forming apparatus 100 comprises a main body (apparatus main body) 100A including four process cartridges 70Y, 70M, 70C, and 70K which are removably mounted to mounting members (not shown) correspondingly to the first, second, third, and fourth image forming portions S, respectively. In the embodiment, the process cartridges are disposed side by side in an inclined manner with respect to a horizontal direction inside the apparatus main body 100A.

In this context, an upstream side and a downstream side in a direction in which the process cartridges 70 are mounted in the image forming apparatus 100 (direction from the near side to the far side of the drawing sheet of FIG. 1) are respectively referred to as a front side and a rear side.

The process cartridge 70 includes a drum-shaped electrophotographic photosensitive member, in other words, a photosensitive drum 1. Processing units such as a charging roller 2, a developing roller 25, and a cleaning member 6 are integrally arranged around the photosensitive drum 1. The charging roller 2 is a charging unit configured to uniformly charge a surface of the photosensitive drum 1. The developing roller 25 is a developing unit configured to develop an electrostatic latent image formed on the photosensitive drum 1 into a visible image with toner. The cleaning member 6 is a cleaning unit configured to remove toner (residual toner), remaining on the photosensitive drum 1, from the photosensitive drum 1 after the toner image formed on the photosensitive drum 1 is transferred onto a recording material P.

Further, the apparatus main body 100A includes a scanner unit 3 provided below the four process cartridges 70Y, 70M, 70C, and 70K. The scanner unit 3 is an exposure unit configured to expose the photosensitive drums 1Y, 1M, 1C, and 1K selectively based on image information so that the electrostatic latent image is formed on the photosensitive drum 1.

A cassette 17 configured to store the recording materials P is removably mounted in a lower portion of the apparatus main body 100A. The apparatus main body 100A also includes a recording material conveying unit configured to convey the recording materials P stored in the cassette 17. The recording material conveying unit conveys the recording materials P upward in the apparatus main body 100A via a secondary transfer roller 69 and an attaching portion 74. The attaching portion 74 is arranged in an upper portion of the apparatus main body 100A. The recording material conveying unit includes a feed roller 54 configured to separate and feed the recording materials P in the cassette 17 one by one, a conveying roller pair 76 configured to convey the recording material P thus fed, and a registration roller pair 55 configured to synchronize the electrostatic latent image formed on the photosensitive drum 1 and the recording material P with each other.

Further, the apparatus main body 100A includes an intermediate transfer unit 5 provided over the four process cartridges 70Y, 70M, 70C, and 70K. The intermediate transfer unit 5 is an intermediate transfer unit configured to transfer the toner images formed on the photosensitive drums 1Y, 1M, 1C, and 1K onto the recording materials P. The intermediate transfer unit 5 includes an intermediate transfer belt 9 which is an endless belt like intermediate transfer member. The intermediate transfer belt 9 is passed over a driving roller 56, a driven roller 57, primary transfer rollers 58Y, 58M, 58C, and 58K, and a secondary transfer opposing roller 59. The primary transfer rollers 58Y, 58M, 58C, and 58K are disposed opposite to the photosensitive drums 1Y, 1M, 1C, and 1K, respectively. The secondary transfer opposing roller 59 is disposed opposite to the secondary transfer roller 69.

The primary transfer rollers 58 are each a primary transfer unit configured to transfer (primarily transfer) the toners on the photosensitive drums 1 onto the intermediate transfer belt 9. The secondary transfer roller 69 is a secondary transfer unit configured to transfer (secondarily transfer) the toner images on the intermediate transfer belt 9 onto the recording materials P. The primary transfer rollers 58 are each pressed toward the photosensitive drum 1 through the intermediate transfer belt 9 so as to form a primary transfer portion (primary transfer position) N1 at which the photosensitive drum 1 and the intermediate transfer belt 9 are in contact with each other. The secondary transfer roller 69 is pressed against the secondary transfer opposing roller 59 through the intermediate transfer belt 9 so as to form a secondary transfer portion (secondary transfer position) N2 at which the intermediate transfer belt 9 and the secondary transfer roller 69 are in contact with each other.

The intermediate transfer belt 9 is moved in circulation while being disposed opposite to and in contact with all the photosensitive drums 1. Then, a voltage is applied to the primary transfer rollers 58 so as to primarily transfer the toner images from the photosensitive drums 1 onto the intermediate transfer belt 9. Further, a voltage is applied to the secondary transfer roller 69 so as to secondarily transfer the toner images from the intermediate transfer belt 9 onto the recording materials P.

Next, how a sequence of image forming operations is performed will be described by way of an example of color image formation. In a case of image formation, in each of the image forming portions S, the photosensitive drum 1 is rotated in a direction indicated by an arrow R1 in FIG. 1. The surface of the photosensitive drum 1 thus rotated is uniformly charged by the charging roller 2, and the scanner unit 3 performs selective exposure onto the photosensitive drum 1 thus charged. In this way, the electrostatic latent image is formed on the photosensitive drum 1. The developing roller 25 supplies toner and develops the electrostatic latent image with the toner. In this way, the toner images of the respective colors are formed on the photosensitive drums 1.

In the respective primary transfer portions N1, the toner images of the respective colors on the photosensitive drums 1 are primarily transferred in a superimposed manner sequentially onto the intermediate transfer belt 9 rotated in a direction indicated by an arrow R2 in FIG. 1. At this time, a primary transfer voltage having a polarity opposite to a regular charging polarity of the toner of the toner images is applied to each of the primary transfer rollers 58.

In synchronism with the toner images on the intermediate transfer belt 9, the registration roller pair conveys the recording materials P to the secondary transfer portion N2. Then, in the secondary transfer portion N2, the toner images on the intermediate transfer belt 9 are secondarily transferred onto the recording materials P. At this time, a secondary transfer voltage having a polarity opposite to the regular charging polarity of the toner of the toner images is applied to the secondary transfer roller 69. In this way, a resultant toner image for a color image to be made from the toner images of the four colors is formed on each of the recording materials P.

The recording material P, on which the resultant toner image for the color image is formed, is heated and pressurized in the attaching portion 74. In this way, the resultant toner image is fixed onto the recording material P. After that, the recording material P is delivered onto a delivery portion 75 by a delivery roller 72. In this way, a recorded image is output.

2. Process Cartridge

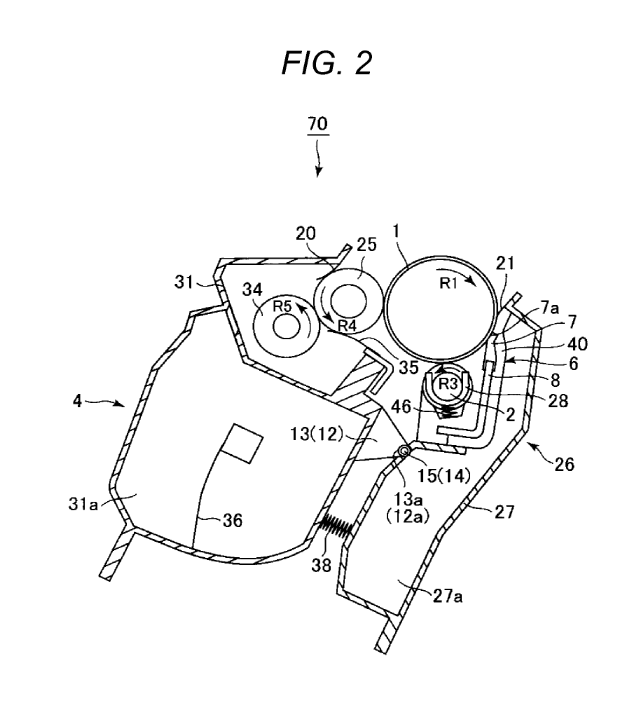

Next, the process cartridge 70 according to the embodiment will be described in more detail. FIG. 2 is a sectional view of the process cartridge 70.

In the embodiment, the cartridge 70Y, which contains a yellow toner, the cartridge 70M, which contains a magenta toner, the cartridge 70C, which contains a cyan toner, and a cartridge 70K, which contains a black toner, are substantially the same in structure.

The process cartridges 70 each include a cleaning unit 26 and a developing unit 4. Note that, in general, the process cartridge is a unit which is removably mounted to a main body of an electrophotographic image forming apparatus. The process cartridge integrally incorporates an electrophotographic photosensitive member and at least one of the processing units such as a charging unit, a developing unit, and a cleaning unit which act on the electrophotographic photosensitive member. In the present invention, the process cartridge includes at least a cleaning unit according to the present invention.

The cleaning unit 26 includes the photosensitive drum 1, the charging roller 2, the cleaning member 6, and a cleaning frame 27 configured to support those components. In the cleaning unit 26, the charging roller 2 and the cleaning member 6 are disposed in contact with an outer peripheral surface of the photosensitive drum 1.

The cleaning member 6 includes a rubber blade 7 which is a blade-shaped elastic member formed of rubber as an elastic material, and a support member 8 configured to support the rubber blade 7. The rubber blade 7 is brought into abutment with the photosensitive drum 1 in a counter direction with respect to a rotational direction of the photosensitive drum 1. In other words, the rubber blade 7 is brought into abutment with the photosensitive drum 1 in a manner that a tip portion 7a thereof is directed to an upstream side in the rotational direction of the photosensitive drum 1. The residual toner removed from the surface of the photosensitive drum 1 by the cleaning member drops into a removed toner chamber 27a formed of the cleaning frame 27. Further, at an edge portion of the cleaning frame 27, which is opposed to the photosensitive drum 1, a scooping sheet 21 configured to prevent leakage of the removed toner in the removed toner chamber 27a is provided in abutment with the photosensitive drum 1. The scooping sheet 21 is a sheet member made of polyester.

In order to drive and rotate the photosensitive drum 1 in the direction indicated by the arrow R1 in FIG. 2 in accordance with the image forming operation, a driving force of a main body drive motor (not shown) as a drive source is transmitted to the cleaning unit 26.

The charging roller 2 is attached in a rotatable manner to the cleaning unit 26 through charging roller bearings 28 at both end portions in a longitudinal direction of the cleaning frame 27 (substantially parallel to a direction of a rotation axis of the photosensitive drum 1). The charging roller bearings 28 are pressed by respective charging roller pressure members 46 toward the photosensitive drum 1 so that the charging roller 2 is brought into pressure contact with the photosensitive drum 1. Along with the rotation of the photosensitive drum 1, the charging roller 2 is rotated in a direction indicated by an arrow R3 in FIG. 2.

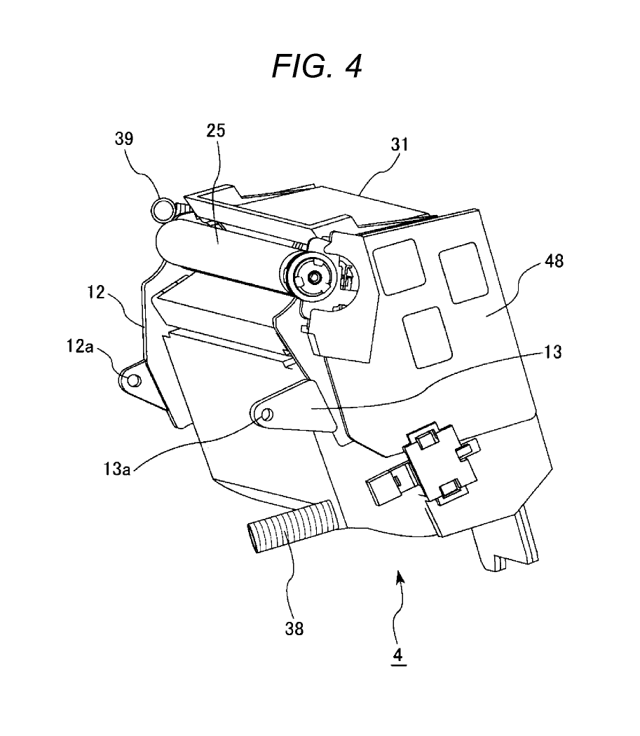

The developing unit 4 includes the developing roller 25 and a developing frame 31 configured to support the developing roller 25. The developing roller 25 is in contact with the photosensitive drum 1 and driven and rotated in a direction indicated by an arrow R4 in FIG. 2. Further, in the developing unit 4, a toner supply roller 34 configured to supply toner to the developing roller 25 and a developing blade 35 configured to regulate a toner layer on the developing roller 25 are arranged in contact with the outer peripheral surface of the developing roller 25. The toner supply roller 34 is driven in contact with the developing roller 25 and rotated in a direction indicated by an arrow R5 in FIG. 2. The developing roller 25 and the toner supply roller 34 are supported in a freely rotatable manner by the developing frame 31 through a developing front bearing 12 and a developing rear bearing 13 fixed respectively on both end portions in a longitudinal direction of the developing frame 31 (substantially parallel to the direction of the rotation axis of the photosensitive drum 1) (FIGS. 2 and 4). Further, at an edge portion of the developing frame 31, which is opposed to the developing roller 25, a blow-out preventing sheet (developing abutment sheet) 20 configured to prevent leakage of toner from the developing frame 31 is provided in abutment with the developing roller 25. Further, a toner containing chamber 31a formed of the developing frame includes a toner conveying member 36 configured to agitate toner contained in the toner containing chamber 31a and convey the toner to the toner supply roller 34.

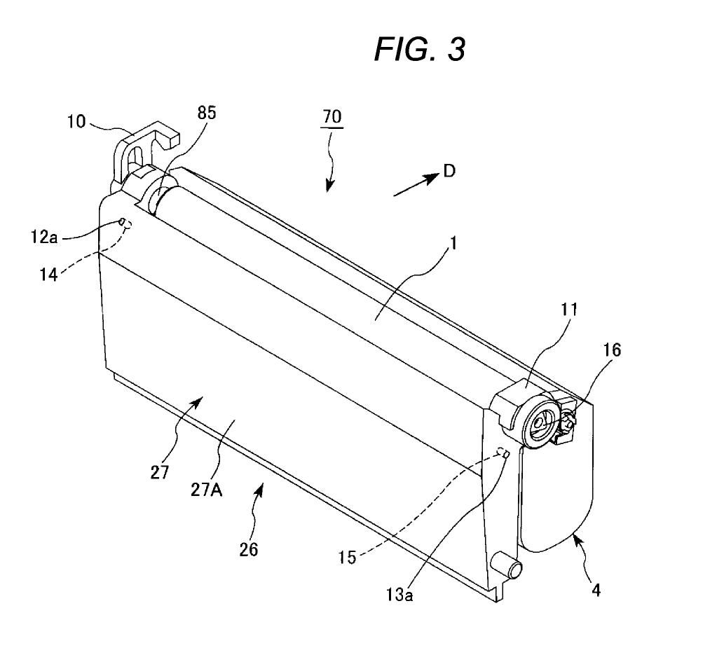

FIG. 3 is an external perspective view of the process cartridge 70. FIG. 4 is an external perspective view of the developing unit 4.

The developing unit 4 is attached by a front support pin 14 and a rear support pin 15 press-fitted respectively into both the end portions in the longitudinal direction of the cleaning frame 27. With this, the developing unit 4 can be swung with respect to the cleaning unit 26. Further, at both the end portions in the longitudinal direction of the cleaning frame 27, there are respectively provided a drum front bearing 10 and a drum rear bearing 11 configured to support the photosensitive drum 1 in a freely rotatable manner. The drum rear bearing supports a drum coupling 16 coupled to the photosensitive drum 1, and the drum front bearing 10 supports a flange 85. In the embodiment, the drum front bearing 10 and the drum rear bearing 11 (second frame part) are coupled to a cleaning frame main body (first frame part) 27A and integrated therewith. With this, cooperatively with the cleaning frame main body 27A, the drum front bearing 10 and the drum rear bearing 11 form the cleaning frame 27 configured to support the photosensitive drum 1 and the cleaning member 6. Note that, the drum front bearing 10 and the drum rear bearing 11 may be formed integrally with the cleaning frame main body 27A.

The developing unit 4 includes the developing frame 31, and the developing front bearing 12 and the developing rear bearing 13 configured to support the developing roller 25 and the toner supply roller 34 in a freely rotatable manner (FIGS. 2 and 4). The developing unit 4 is urged toward the cleaning unit 26 by a pressure spring 38 provided on the developing frame 31 and a tension spring 39 provided on the developing front bearing 12. The pressure spring 38 and the tension spring 39 are pressure members configured to apply a pressing force to the developing roller 25 so as to bring the developing roller 25 into contact with the photosensitive drum 1 at a time of image formation with the process cartridge 70. The pressure spring 38 as a compression spring is disposed between the cleaning frame 27 and the developing frame 31. Further, the tension spring 39 has both ends hooked respectively to the developing front bearing 12 and the drum front bearing 10. The pressure spring 38 and the tension spring 39 cause the developing unit 4 to be swung with respect to the cleaning unit 26 about respective holes 12a and 13a of the developing front bearing 12 and the developing rear bearing 13. In this way, the pressing force for bringing the developing roller 25 into abutment with the photosensitive drum 1 is exerted on the developing roller 25.

Note that, in a contact developing process in which the photosensitive drum 1 and the developing roller are brought into contact with each other so as to perform a development, it is preferred that the photosensitive drum 1 be a rigid member, and the developing roller 25 be a roller including an elastic member. Examples of the elastic member include a solid rubber single layer, and a solid rubber layer coated with a resin in order to secure an electric charge giving property of giving an electric charge to toner.

3. Cleaning Unit

Next, how to support the cleaning member 6 of the cleaning unit 26 according to the embodiment will be described in detail.

In the embodiment, in order, for example, to reduce rotational torque of the photosensitive drum 1, the cleaning member 6 which abuts against the photosensitive drum 1 is supported in a pivotable manner by the cleaning frame 27. This is because, when a separate member such as a pin is used as described above for supporting the cleaning member 6 in a pivotable manner, a larger number of components and higher cost thereof are required. In addition, the structure is liable to be complicated.

It is a main object in the embodiment to support the cleaning member in a pivotable manner with a simple structure such as the frame without use of the separate member such as the pin, to thereby achieve reduction in manufacturing cost and to enable easier assembly.

In the following, only one end portion (front end portion) in a longitudinal direction of the process cartridge 70 (substantially parallel to the direction of the rotation axis of the photosensitive drum 1) will be described in detail. Meanwhile, the other end portion (rear end portion), which has substantially the same (substantially symmetrical) structure, is not described unless it is necessary to make specific description.

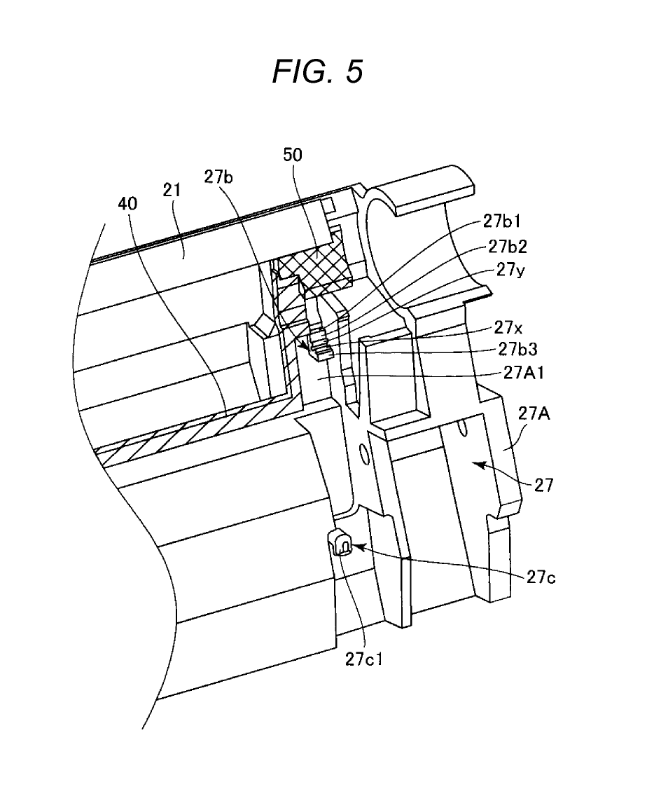

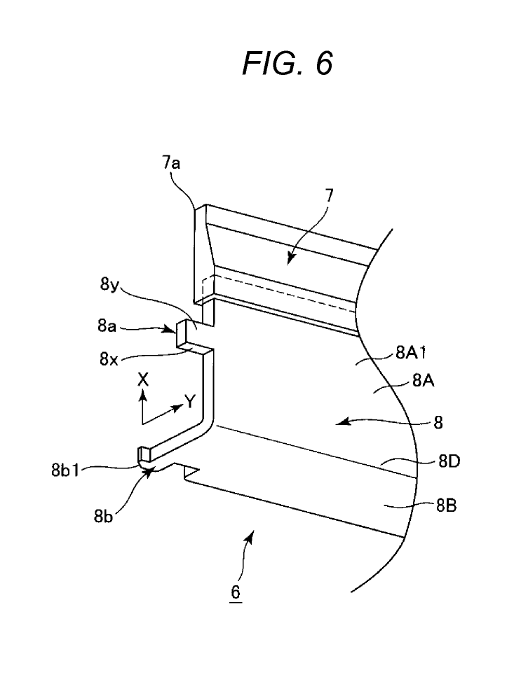

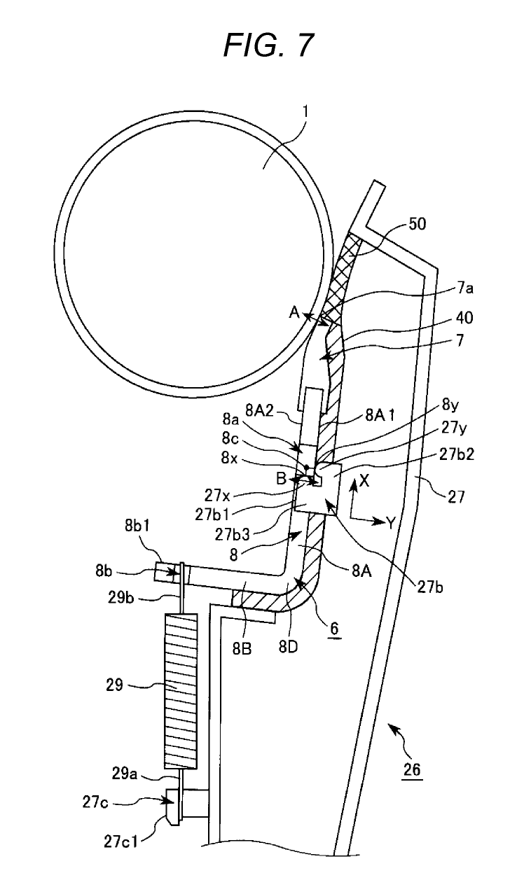

FIG. 5 is a perspective view of an inner surface 27A1 of the cleaning frame 27 (in particular, cleaning frame main body 27A). FIG. 6 is a perspective view of one end portion (front end portion) in a longitudinal direction of the cleaning member 6 (substantially parallel to the direction of the rotation axis of the photosensitive drum 1) as viewed from the side of the inner surface 27A1 of the cleaning frame 27. FIG. 7 is a sectional view of a substantial part of the cleaning unit 26.

The cleaning unit 26 includes the rotatable photosensitive drum 1, the cleaning member 6 configured to remove toner from the photosensitive drum 1, and the cleaning frame 27 as a frame configured to support the photosensitive drum 1 and the cleaning member 6. The cleaning member 6 includes the elastic member 7 which abuts against the photosensitive drum 1, and the support member 8 configured to support the elastic member 7. In the embodiment, as described above, the elastic member 7 is a rubber blade formed of rubber as an elastic material. Further, the support member 8 used in the embodiment has an outer shape formed by punching out a sheet metal, which is a flat metal plate material, through press working. Urethane rubber can be suitably used as the rubber material for the rubber blade 7. Further, a plated steel plate can be suitably used as a material for the support member 8. Alternatively, a stainless steel plate may be used.

In particular, in the embodiment, as illustrated in FIGS. 6 and 7, the support member 8 is formed by bending a single continuous sheet metal punched out through press working, at a predetermined position (bent part) 8D in a lateral direction thereof, over the entire region in a longitudinal direction of the support member 8. With this, the support member 8 is formed into a substantial L-shape in cross-section as viewed in the direction of the rotation axis of the photosensitive drum 1. In the embodiment, the bent part 8D is curved into a circular-arc shape in cross-section as viewed in the direction of the rotation axis of the photosensitive drum 1. In other words, the support member 8 includes a plate-shaped main part 8A substantially parallel to the direction of the rotation axis of the photosensitive drum 1, and a strengthening part 8B bent in a direction in which the strengthening part 8B intersects with the main part 8A at the bent part 8D. In the embodiment, the strengthening part 8B is bent to project toward the photosensitive drum 1 with respect to the main part 8A. With this, at the time of attachment of the cleaning frame 27 to the photosensitive drum 1, deflection in the longitudinal direction of the cleaning member 6 is suppressed. Note that, in the embodiment, the strengthening part 8B is bent in a direction substantially orthogonal to the main part 8A. However, the present invention is not limited thereto. Further, a side surface of the main part 8A of the support member 8, which is on the side of the inner surface 27A1 of the cleaning frame 27, is defined as a first side surface 8A1, and an opposite side surface of the main part 8A of the support member 8, which is on the side of the photosensitive drum 1, is defined as a second side surface 8A2. The rubber blade 7 is coupled to and integrated with an edge portion of the support member 8 opposite to the bent part 8D in the lateral direction of the main part 8A of the support member 8. The rubber blade 7 is provided continuously over the entire region in a longitudinal direction of the main part 8A of the support member 8.

As illustrated in FIG. 5, the cleaning frame 27 includes a cleaning member support portion (hereinafter also simply referred to as “support portion”) 27b configured to support the cleaning member 6. The support portion 27b includes a first support portion 27y and a second support portion 27x which abut against the cleaning member 6. The support portion 27b will be described in further detail below.

The cleaning frame 27 also includes a sealing member 40 configured to seal a gap between the cleaning frame 27 and the cleaning member 6. Specifically, the sealing member 40 seals a gap between the cleaning frame 27 and the rubber blade 7 and a gap between the cleaning frame 27 and the support member 8 near each of the end portions in the longitudinal direction of the cleaning member 6. Further, the sealing member 40 also seals a gap between the support member 8 and the cleaning frame 27 near an edge portion of the main part 8A of the support member 8 on a side opposite to the rubber blade 7 in the lateral direction of the support member 8. Further, the cleaning frame 27 includes an end portion sealing member 50 configured to seal a gap among the cleaning frame 27, the cleaning member 6, and the photosensitive drum 1. Specifically, the end portion sealing member 50 seals a gap between the photosensitive drum 1 and the cleaning frame 27 and a gap between the rubber blade 7 and the cleaning frame 27 at a corner portion of the tip portion 7a of the rubber blade 7 near the end portion in the longitudinal direction of the cleaning member 6.

The sealing member 40 is an elastic sealing member made of polyurethane foam or elastomer. Meanwhile, each of the end portion sealing members 50 is a sealing member made of pile, nonwoven fabric, or felt.

Further, the cleaning frame 27 includes a boss 27c as a frame side urging member attaching portion configured to attach a tension spring 29 (FIG. 7) as an urging member described below. In the embodiment, the boss 27c is a substantially columnar protrusion provided upright on the inner surface 27A1 of the cleaning frame 27. The boss 27c has a distal end provided with a claw-like engagement portion 27c1 configured to engage one end portion 29a of the tension spring 29.

Meanwhile, as illustrated in FIG. 6, an end portion in the longitudinal direction of the main part 8A of the support member 8 is provided with a frame abutment portion (hereinafter also simply referred to as “abutment portion”) 8a which is projected to abut against the cleaning frame 27. The cleaning member 6 abuts against the support portion 27b of the cleaning frame 27 at the abutment portion 8a, and is supported by the cleaning frame in a pivotable manner (swingable manner) about the abutment portion 8a as a pivot axis.

In the embodiment, the abutment portion 8a is formed into a substantially rectangular parallelepiped shape in which one side surface of the abutment portion 8a is continuous with a side surface of the end portion in the longitudinal direction of the main part 8A of the support member 8. The one side surface of side surfaces of the abutment portion 8a, which is flush with the first side surface 8A1 of the main part 8A of the support member 8, serves as a first abutment portion 8y described below. Further, a side surface of the side surfaces of the abutment portion 8a opposite to the rubber blade 7 in the lateral direction of the main part 8A serves as a second abutment portion 8x described below.

As viewed in the direction of the rotation axis of the photosensitive drum 1, a direction toward the tip portion 7a of the rubber blade 7 along an axis of the main part 8A of the support member 8 (substantially parallel to the first side surface 8A1 or the second side surface 8A2) is defined as an X direction. Further, as viewed in the direction of the rotation axis of the photosensitive drum 1, a direction perpendicular to the X direction and toward a side opposite to the photosensitive drum 1 with respect to the cleaning member 6 is defined as a Y direction. Still further, a direction directly opposite to the X direction is defined as a −X direction, and a direction directly opposite to the Y direction is defined as a −Y direction. As viewed in the direction of the rotation axis of the photosensitive drum 1, a first axis extending from the abutment portion 8a to the rubber blade 7 is a direction along the X direction. Further, a second axis substantially orthogonal to the first axis is a direction along the Y direction.

The abutment portion 8a includes the first abutment portion 8y which abuts against the first support portion 27y of the support portion 27b, and the second abutment portion 8x which abuts against the second support portion 27x of the support portion 27b. In the embodiment, the first abutment portion 8y is formed of a surface directed in the Y direction of the abutment portion 8a, and the second abutment portion 8x is formed of a surface directed in the −X direction of the abutment portion 8a.

In this way, the support member 8 has the abutment portion 8a provided on each of both the end portions of the support member 8 in the direction along the direction of the rotation axis of the photosensitive drum 1. The abutment portion 8a abuts against the cleaning frame 27 at a corresponding one of both the end portions of the cleaning frame 27. The abutment portion 8a has the first abutment portion 8y and the second abutment portion 8x which are formed of respective surfaces extending in directions intersecting with each other. As viewed in the direction of the rotation axis of the photosensitive drum 1, the first abutment portion 8y is directed to a side opposite to the side of the photosensitive drum 1 with respect to the first axis, and the second abutment portion 8x is directed to an opposite side which is opposite to the side of the elastic member 7 with respect to the second axis.

As described above, in the embodiment, the support member 8 is formed of a sheet metal (blank) punched out through press working. Thus, the second abutment portion 8x is formed of a machined surface (cut edge surface) obtained through the press working. In this case, the surfaces of the first abutment portion 8y and the second abutment portion 8x are substantially orthogonal to each other. Note that, when desired, the surfaces of the first abutment portion 8y and the second abutment portion 8x may intersect with each other at other angle.

Further, the support member 8 of the cleaning member 6 includes an urging member attaching portion (hereinafter also simply referred to as “attaching portion”) 8b configured to attach the tension spring 29. In the embodiment, the attaching portion 8b is provided at a distal end portion of an end portion in a longitudinal direction of the strengthening part 8B of the support member 8. The attaching portion 8b has a distal end provided with a claw-like engagement portion 8b1 configured to engage the other end portion 29b of the tension spring 29. With this, in the embodiment, the tension spring 29 exerts an urging force on an acting portion projected from the main part 8A of the support member 8 toward the photosensitive drum 1 along a direction intersecting with the main part 8A of the support member 8 (in the embodiment, direction substantially orthogonal to the main part 8A).

The configuration described above will be described below in further detail with reference to FIG. 7 illustrating a state in which the cleaning member 6 is in abutment with the photosensitive drum 1 while the process cartridge 70 is maintained in a stationary state and rotation of the photosensitive drum 1 is stopped.

In the cleaning frame 27, the first support portion 27y and the second support portion 27x are positioned opposite to the first abutment portion 8y and the second abutment portion 8x of the cleaning member 6, respectively. The first support portion 27y is brought into contact with the first abutment portion 8y and receives a Y direction force which is exerted on the cleaning member 6. The second support portion 27x is brought into contact with the second abutment portion 8x and receives a −X direction force which is exerted on the cleaning member 6.

In this way, the cleaning frame 27 has the support portions 27b which abut against the abutment portions 8a provided on both the end portions of the support member 8 in the direction along the direction of the rotation axis of the photosensitive drum 1. The support portion 27b includes the first support portion 27y which abuts against the first abutment portion 8y and the second support portion 27x which abuts against the second abutment portion 8x, and supports the cleaning member 6 in a pivotable manner about the abutment portion 8a as a pivot axis.

A pivot center (swing center) 8c of the cleaning member 6 substantially corresponds to an intersection of a straight line extending in the −Y direction from a contact position (tangent point) between the first support portion 27y and the first abutment portion 8y, and a straight line extending in the X direction from a contact position between the second support portion 27x and the second abutment portion 8x. In other words, as viewed in the direction of the rotation axis of the photosensitive drum 1, the pivot center 8c corresponds to an intersection of a straight line extending along the above-mentioned second axis from the contact position between the first abutment portion 8y and the first support portion 27y, and a straight line extending along the above-mentioned first axis from the contact position between the second abutment portion 8x and the second support portion 27x.

Further, in order to bring the rubber blade 7 of the cleaning member 6 into abutment with the photosensitive drum 1, the other end portion 29b of the tension spring 29 is fixed to the attaching portion 8b of the support member 8, and the one end portion 29a of the tension spring 29 is fixed to the boss 27c of the cleaning frame 27. The urging force of the tension spring 29 applies a rotational moment about the pivot center 8c to the cleaning member 6. With this, the tip portion 7a of the rubber blade 7 is brought into abutment with the photosensitive drum 1.

In this way, the cleaning unit 26 has the tension spring 29 serving as an urging member configured to urge the cleaning member 6 in a direction in which the rubber blade 7 is brought into contact with the photosensitive drum 1 by pivoting the cleaning member 6 about the abutment portion 8a as a pivot axis.

When the photosensitive drum 1 is rotated, for example, at the time of image formation, the rubber blade 7 of the cleaning member 6 is moved in directions indicated by arrows A in FIG. 7 due to, for example, vibration of the photosensitive drum 1. In that case, the cleaning member 6 pivots about the abutment portion 8a as a pivot axis. Specifically, the second abutment portion 8x of the abutment portion 8a pivots about the pivot center 8c in directions indicated by arrows B in FIG. 7.

In the embodiment, the first support portion 27y and the second support portion 27x are each formed into a circular-arc shape in cross-section as viewed in the direction of the rotation axis of the photosensitive drum 1. In further detail, in the embodiment, the support portion 27b of the cleaning frame 27 is formed on a rack portion 27b1 which has a substantial L-shape in cross-section as viewed in the direction of the rotation axis of the photosensitive drum 1 and is projected from the inner surface 27A1 of the cleaning frame 27. The first support portion 27y is formed on a vertical rack portion 27b2 along the X direction of the rack portion 27b1. The second support portion 27x is formed on a horizontal rack portion 27b3 along the −Y direction of the rack portion 27b1. The cleaning member 6 is supported at one point on an outer peripheral surface of the first support portion 27y and one point on an outer peripheral surface of the second support portion 27x in cross-section as viewed in the direction of the rotation axis of the photosensitive drum 1. In other words, along lines on the respective outer peripheral surfaces of the first support portion 27y and the second support portion 27x, which each extend along the direction of the rotation axis of the photosensitive drum 1, the first support portion 27y and the second support portion 27x are in contact with the first abutment portion 8y and the second abutment portion 8x, respectively. In this way, when the first support portion 27y and the second support portion 27x are each formed into a circular-arc shape in cross-section, contact resistances with respect to the abutment portion 8a can be reduced. As a result, the cleaning member 6 can be more smoothly moved.

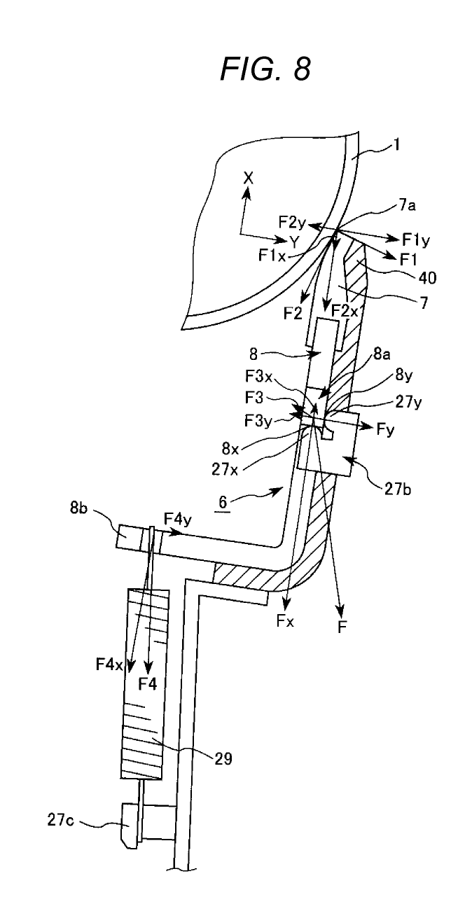

Next, a force F which is exerted on the cleaning member 6 will be described with reference to FIG. 8. FIG. 8 is a view of a substantial part of the cleaning unit 26, for illustrating the force F exerted on the cleaning member 6.

The force F which is exerted on the cleaning member 6 includes a drum abutment force F1 generated by bringing the rubber blade 7 into abutment with the photosensitive drum 1 by a desired pressing force, a frictional force F2 generated by driving the photosensitive drum 1, a repulsive force F3 generated by the sealing member 40, and a spring tension F4 generated by the tension spring 29.

The force F which is exerted on the cleaning member 6 also includes a force Fx in the X direction as a resultant force Fx of an X component Fix of the drum abutment force F1, an X component F2x of the frictional force F2, an X component F3x of the repulsive force F3, and an X component F4x of the spring tension F4, which is expressed as follows: Fx=F1x+F2x+F3x+F4x. Note that, when the rotation of the photosensitive drum 1 is stopped, the X component F2x is zero.

On the other hand, the force F which is exerted on the cleaning member 6 also includes a force Fy in the Y direction as a resultant force Fy of a Y component Fly of the drum abutment force F1, a Y component F2y of the frictional force F2, a Y component F3y of the repulsive force F3, and a Y component F4y of the spring tension F4, which is expressed as follows: Fy=F1y+F2y+F3y+F4y. Note that, when the rotation of the photosensitive drum 1 is stopped, the Y component F2y is zero.

In order that the force F as a total resultant force of the resultant force Fx of the X components F1x to F4x and the resultant force Fy of the Y components F1y to F4y is generated in a direction of bringing the first abutment portion 8y and the second abutment portion 8x into abutment with the first support portion 27y and the second support portion 27x, respectively, the resultant force Fx of the X components F1x to F4x and the resultant force Fy of the Y components F1y to F4y are set. For example, the total resultant force F can be adjusted through adjustment of tension or a pulling direction of the tension spring 29. With the total resultant force F, the cleaning member 6 can be stably supported by the cleaning frame 27. In other words, through such adjustment of the total resultant force F which is exerted on the cleaning member 6, the cleaning member 6 can be pivoted in a state in which the first abutment portion 8y and the second abutment portion 8x are in continuous abutment with the first support portion 27y and the second support portion 27x, respectively, in use of the process cartridge 70.

In the embodiment, the repulsive force F3 generated by the sealing member 40 is taken into account as a component of the total resultant force F for supporting the cleaning member 6. However, for example, when the repulsive force F3 by the sealing member 40 is small, the repulsive force F3 may be ignored. In such a case, in order to seal the gaps between the cleaning member 6 and the cleaning frame 27, after the cleaning member 6 is assembled to the cleaning frame 27, expandable urethane foam may be injected and used as a sealing member. In this case, a repulsive force applied from the sealing member to the cleaning member 6 is minute, and hence the cleaning member 6 can be supported without taking the repulsive force F3 generated by the sealing member 40 into account. Further, in the embodiment, an influence of a weight of the cleaning member 6 itself on the total resultant force F; specifically, on each of the drum abutment force F1, the frictional force F2, the repulsive force F3, and the spring tension F4 is ignorable. However, in some cases, it is necessary to adjust the total resultant force F while taking the weight of the cleaning member 6 itself into account.

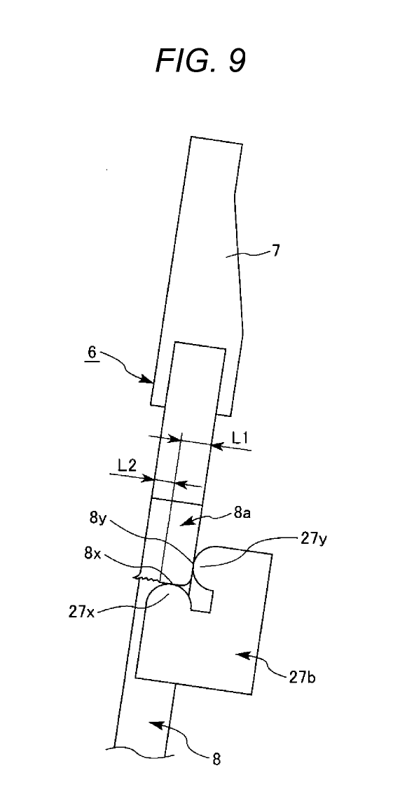

In addition, as illustrated in FIG. 9, the abutment portion 8a is formed through press working (blanking) on a sheet metal. Thus, the side surface as the second abutment portion 8x of the abutment portion 8a opposite to the second support portion 27x involves a shear surface zone L1 and a fracture surface zone L2. In the embodiment, the second support portion 27x is brought into abutment with a part of the second abutment portion 8x, which corresponds to the shear surface zone L1. This is because, normally, dimensions of a machined surface of the sheet metal, which is obtained through the press working, are defined based on the shear surface zone. Thus, the shear surface zone L1 corresponding to the part of the second abutment portion 8x tends to be formed with high dimensional accuracy, and hence performance of the cleaning member 6 can be stabilized. Further, a surface roughness of the machined surface of the sheet metal, which is obtained through the press working, is smaller in the shear surface zone L1 than in the fracture surface zone L2. Thus, when the second support portion 27x is brought into abutment with the shear surface zone L1, a support position of the cleaning member 6 is stabilized, and the second support portion 27x is prevented from being ground.

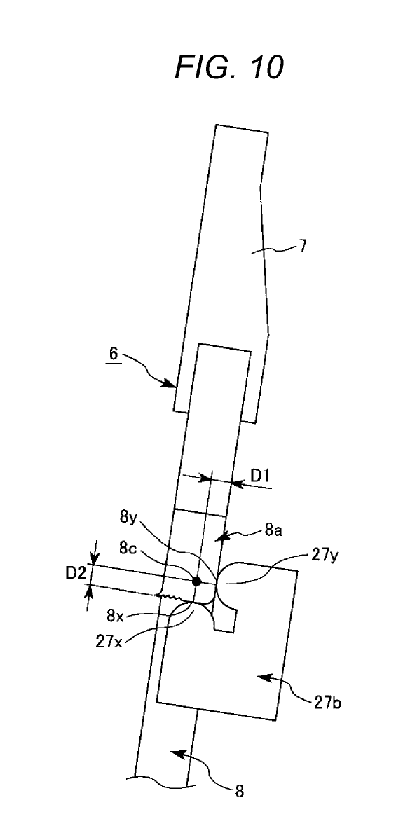

Further, FIG. 10 illustrates a distance D1 from the contact position between the first abutment portion 8y and the first support portion 27y to the above-mentioned pivot center 8c, and a distance D2 from the contact position between the second abutment portion 8x and the second support portion 27x to the above-mentioned pivot center 8c. The distance D1 and the distance D2 are set to be substantially equal to each other (D1≈D2). In other words, the first support portion 27y and the second support portion 27x are arranged so that the distance D1 and the distance D2 satisfy this relationship. With such an arrangement, even when the cleaning member 6 is pivoted due to, for example, vibration of the photosensitive drum 1, for example, at the time of image formation, a displacement amount which causes movement of the pivot center 8c in the abutment portion 8a can be suppressed to a minimum.

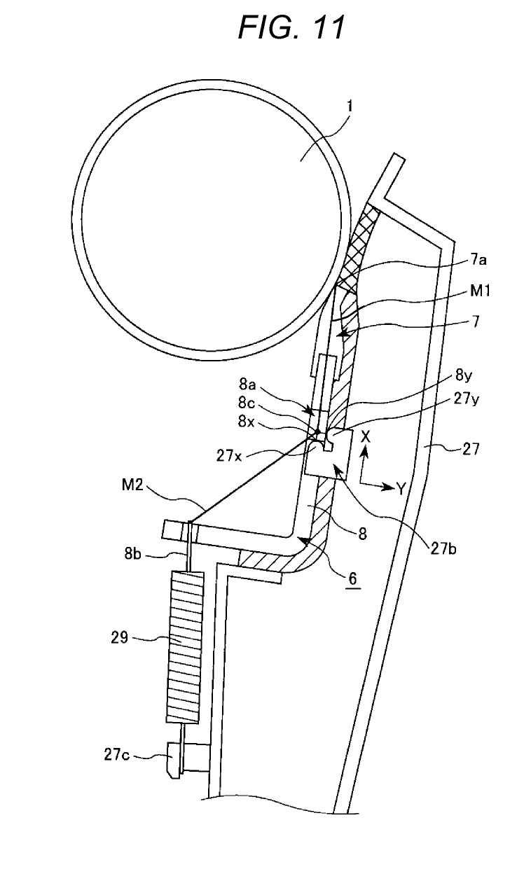

Further, FIG. 11 illustrates a distance M1 from the above-mentioned pivot center 8c to the tip portion 7a of the rubber blade 7, and a distance M2 from the above-mentioned pivot center 8c to the attaching portion (acting portion which is urged by the urging member) 8b of the support member 8. The distance M1 and the distance M2 are set to be substantially equal to each other (M1≈M2). In other words, the tip portion 7a of the rubber blade 7, the above-mentioned pivot center 8c, and the attaching portion 8b are arranged so that the distance M1 and the distance M2 satisfy this relationship. With such an arrangement, variation in abutment pressure of the cleaning member 6 with respect to the photosensitive drum 1 due to fluctuations in tension of the tension spring 29 can be suppressed. Simultaneously, the cleaning member 6 can be downsized in cross-section as viewed in the direction of the rotation axis of the photosensitive drum 1.

When the distance M1 is larger than the distance M2 (M1>M2), the cleaning member 6 can be thinned in the Y direction. However, it is necessary to increase the urging force so that the rubber blade 7 is brought into abutment with the photosensitive drum 1 by a desired pressing force, in other words, to increase a spring force of the tension spring 29. Thus, it may be necessary to increase a thickness of the sheet metal of the support member 8 configured to support the tension spring 29. Further, it may be also necessary to increase a strength of the support portion 27b of the cleaning frame 27. However, those necessities may leads to a cost increase. Meanwhile, when the distance M1 is smaller than the distance M2 (M1<M2), the spring force of the tension spring 29 can be reduced. However, it is necessary to increase a projecting amount of the attaching portion 8b from the main part 8A of the support member 8, and hence it is necessary to increase a size in the projecting direction of the process cartridge 70. As a result, the apparatus main body 100A may increase in size. Meanwhile, when the structures satisfying the relationship of M1≈M2 are set as described above, the process cartridge 70 is well-balanced in size and strength. Thus, in the embodiment, the structures satisfying the relationship of M1≈M2 are employed.

4. Assembly Procedure

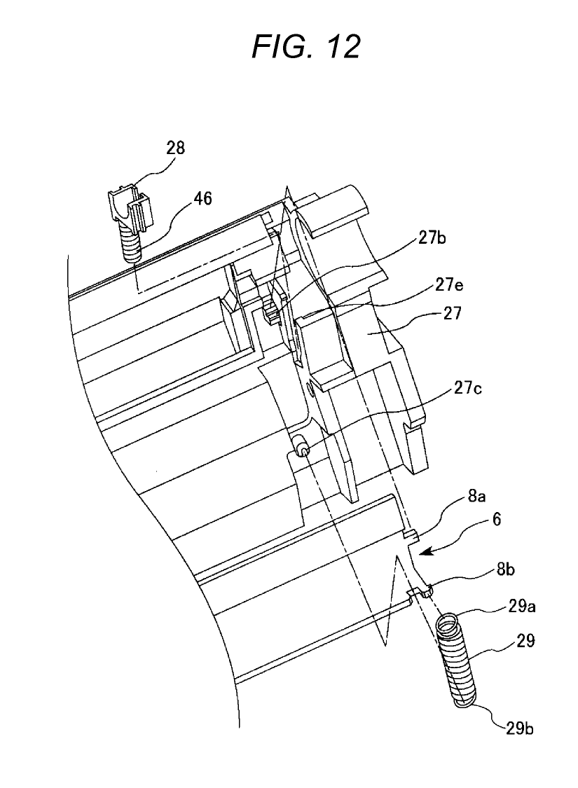

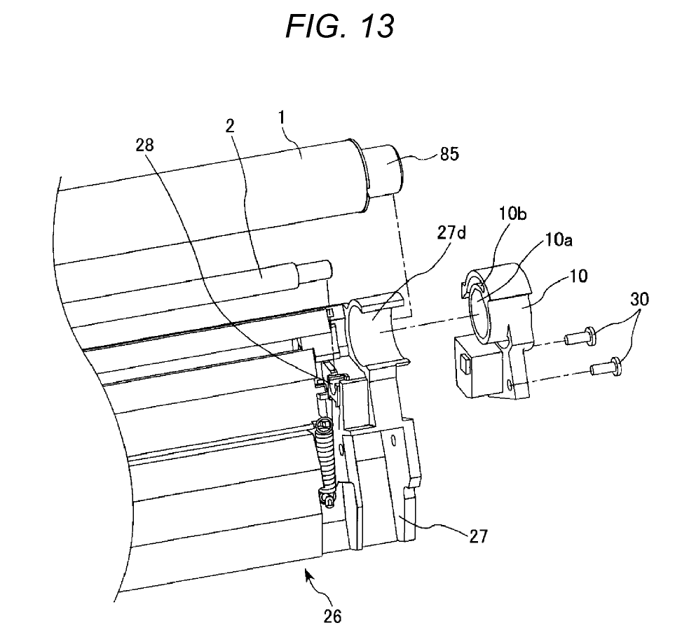

Next, a procedure for assembling the cleaning unit 26 according to the embodiment will be described. FIGS. 12 and 13 are partially exploded perspective views of the cleaning unit 26, for illustrating the procedure for assembling the cleaning unit 26.

As illustrated in FIG. 12, first, the cleaning member 6 is temporarily set in a manner that the abutment portion 8a of the cleaning member 6 abuts against the support portion 27b of the cleaning frame 27.

Next, the charging roller bearing 28 and the charging roller pressure member 46 are mounted to a receiving portion 27e of the cleaning frame 27 (FIG. 12). Then, the charging roller 2 is mounted to the charging roller bearing 28. Thus, the charging roller 2 can be fixed to the cleaning frame 27 (FIG. 13).

Next, as illustrated in FIG. 13, the flange 85 of the photosensitive drum 1 is temporarily set to a drum positioning portion 27d of the cleaning frame 27. The drum positioning portion 27d has an inner diameter dimension larger than an outer diameter dimension of the flange 85 of the photosensitive drum 1. In this way, the photosensitive drum 1 is temporarily positioned to the cleaning frame 27.

Next, the drum front bearing 10 is mounted to the cleaning frame 27 in the direction of the rotation axis of the photosensitive drum 1. The drum front bearing 10 includes a rotary shaft support portion 10a for the photosensitive drum 1. With this, when the drum front bearing 10 is attached to the cleaning frame 27, the photosensitive drum 1 and the rotary shaft support portion 10a are positioned with respect to each other. A bearing positioning portion 10b of the drum front bearing 10 and the drum positioning portion 27d of the cleaning frame 27 are each formed to have dimensions so as to be fitted to each other. Through engagement of those portions, the drum front bearing 10 is positioned with respect to the cleaning frame 27. Further, the drum front bearing 10 and the cleaning frame 27 respectively include positioning units (not shown) configured to position the drum front bearing and the cleaning frame 27 in a sectional direction (rotational direction) substantially orthogonal to the direction of the rotation axis of the photosensitive drum 1. Through engagement of those units, the drum front bearing and the cleaning frame 27 are positioned in the sectional direction.

In this state, the drum front bearing 10 and the cleaning frame 27 are fixed to each other with fixing units such as screws 30. With this, assembling of the drum front bearing 10 to the cleaning frame 27 is completed.

Lastly, the tension spring 29 is stretched between the attaching portion 8b of the cleaning member 6 and the boss 27c of the cleaning frame 27 (FIGS. 12 and 13).

The procedure for assembling the cleaning unit 26 will be described with a focus only on one end portion (front end portion) in a longitudinal direction of the cleaning unit 26. However, the same procedure as above is synchronously performed also on the other end portion (rear end portion) of the cleaning unit 26. Note that, at the other end portion (rear end portion) of the cleaning unit 26, the drum rear bearing 11 is attached to the cleaning frame 27 by the same method as above.

With this, assembling the cleaning unit 26 is completed, and the cleaning member 6 abuts against the photosensitive drum 1 by a predetermined pressure. In this way, preparation of cleaning is completed.

As described above, according to the embodiment, the cleaning member can be supported in a pivotable manner with a simple structure such as the frame without use of the separate member such as the pin, to thereby achieve reduction in manufacturing cost and to enable easier assembly.

Further, in the embodiment, the support portion 27b of the cleaning frame 27 is made of plastic, and integrated with the cleaning frame 27 (specifically, cleaning frame main body 27A). Further, the abutment portion 8a of the cleaning member 6 is formed simultaneously with the press working in which a sheet metal is punched out to form the support member 8 of the cleaning member 6. Thus, according to the embodiment, the numbers of manufacturing steps for the cleaning frame 27 as a support structure for the cleaning member 6, and the cleaning member 6 itself are small, which is advantageous in reduction in manufacturing cost and stabilization of manufacturing accuracy.

Note that, as described above in the embodiment, the first support portion 27y and the second support portion 27x of the support portion 27b of the cleaning frame 27 are each formed into the circular-arc shape in cross-section as viewed in the direction of the rotation axis of the photosensitive drum 1. However, the shape of the support portion 27b is not limited thereto.

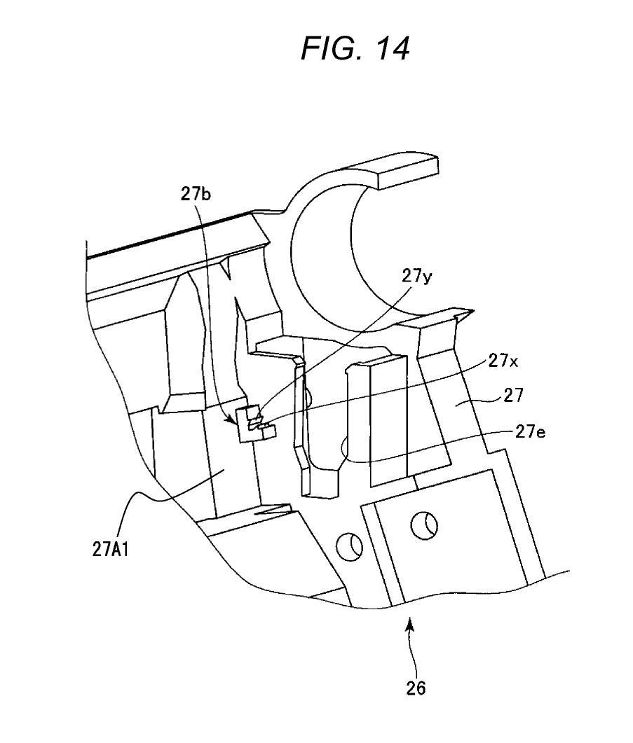

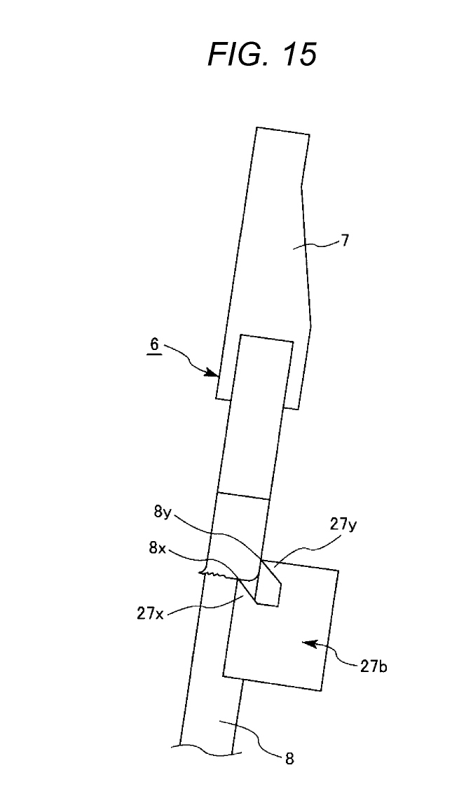

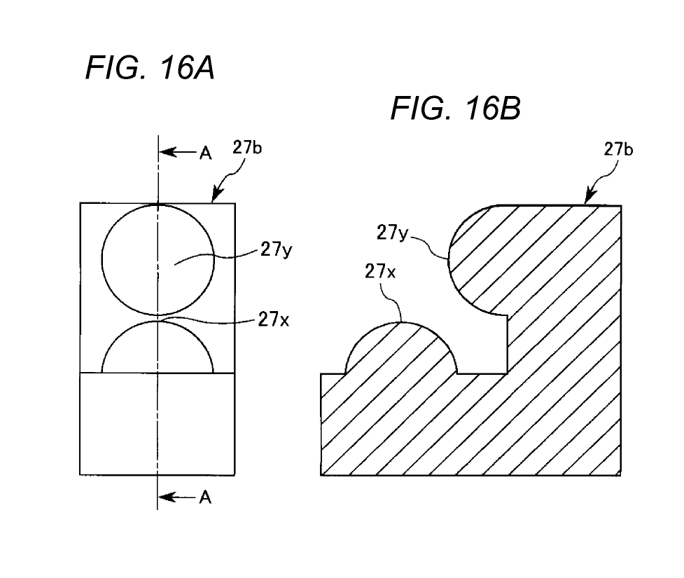

For example, with another shape as illustrated in FIGS. 14 and 15, the same advantages as those in the embodiment can be obtained. FIG. 14 is a partial perspective view of the inner surface 27A1 of the cleaning frame 27 (specifically, cleaning frame main body 27A). FIG. is a still another partial sectional view of a substantial part of the cleaning member 6 and the cleaning frame 27, for illustrating how the abutment portion 8a of the cleaning member 6 and the support portion 27b of the cleaning frame 27 are in abutment with each other. As illustrated in FIGS. 15 and 16, the first support portion 27y and the second support portion 27x as viewed in the direction of the rotation axis of the photosensitive drum 1 each may be formed into a protruding shape having an apex in cross-section. Also in this case, as described above in the embodiment, the first support portion 27y and the second support portion 27x are in contact with the first abutment portion 8y and the second abutment portion 8x, respectively, at the apices along straight lines extending in the direction of the rotation axis of the photosensitive drum 1.

Alternatively, as still another example, as illustrated in FIGS. 16A and 16B, the first support portion 27y and the second support portion 27x may be in point contact with the first abutment portion 8y and the second abutment portion 8x, respectively. FIG. 16A is a front view in which the support portion 27b of the cleaning frame 27 is viewed from the cleaning member 6, and FIG. 16B is a sectional view of the support portion 27b of the cleaning frame 27. In the example illustrated in FIGS. 16A and 16B, two dome-shaped apices formed on the support portion 27b of the cleaning frame 27 serve as the first support portion 27y and the second support portion 27x, respectively. As a matter of course, the shape of the support portion 27b is not limited to the above-mentioned circular-arc shape or the protruding shape having the apex. Even in a case of using the first support portion 27y and the second support portion 27x of the support portion 27b, which each have such a shape of the still another example, the same advantages as those in the case of using the first support portion 27y and the second support portion 27x of the support portion 27b, each having the circular-arc shape described above in the embodiment, can be obtained.

### Second Embodiment

Next, another embodiment of the present invention will be described. The basic structures of a cleaning unit, a process cartridge, and an image forming apparatus according to the embodiment are the same as those of the first embodiment. Therefore, in the embodiment, components having the same functions and structures as those of the first embodiment or having the functions and structures corresponding thereto are denoted by the same reference symbols, and detailed description thereof is omitted.

In the following, only the one end portion (front end portion) in the longitudinal direction of the process cartridge 70 (substantially parallel to the direction of the rotation axis of the photosensitive drum 1) will be described in detail. Meanwhile, the other end portion (rear end portion), which has substantially the same (substantially symmetrical) structure, is not described unless it is necessary to make specific description.

In the embodiment, even when the abutment portion 8a of the cleaning member 6 is displaced with respect to the support portion 27b of the cleaning frame 27 during transportation, the cleaning member 6 is returned to the original position by an urging force of an urging member. In this way, a position of the cleaning member 6 is stabilized. Further, in the embodiment, displacement in the longitudinal direction of the cleaning member 6 with respect to the cleaning frame 27 is suppressed.

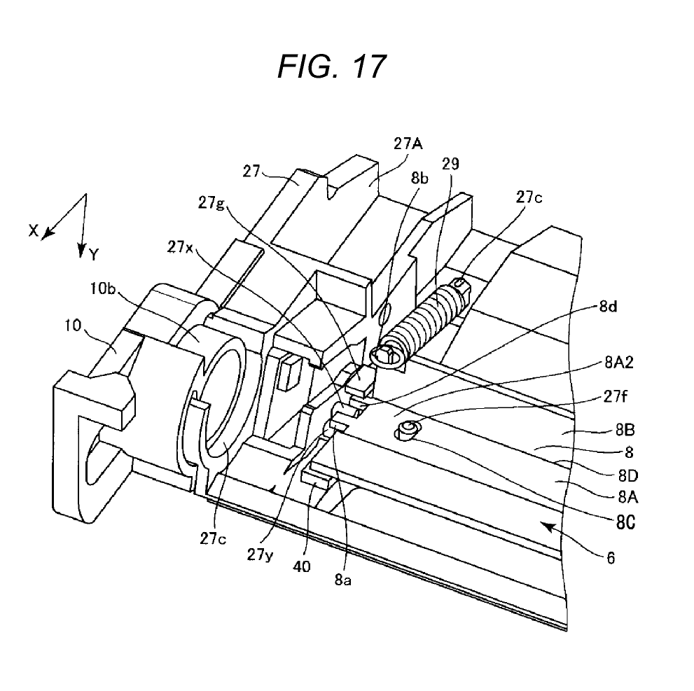

First, how to position the cleaning member 6 according to the embodiment in the longitudinal direction will be described. FIG. 17 is a perspective view of the cleaning unit 26 as viewed from the drum front bearing 10 side in a state in which the photosensitive drum 1, the charging roller 2, and so on are removed.

As illustrated in FIG. 17, in the embodiment, the cleaning member 6 is provided with a positioning hole 8C configured to position the cleaning member 6 in the longitudinal direction with respect to the cleaning frame 27. In the embodiment, the positioning hole 8C is an elongate hole formed near the end portion in the longitudinal direction of the main part 8A of the support member 8 and extending in the direction substantially orthogonal to the longitudinal direction of the main part 8A of the support member 8. The positioning hole 8C is engaged with a positioning boss 27f provided on the cleaning frame 27. With this, the cleaning member 6 can be positioned in the longitudinal direction with respect to the cleaning frame 27 in a state in which the cleaning member 6 is pivotable about the abutment portion 8a as a pivot axis. In the embodiment, the positioning boss 27f is a substantially columnar protrusion provided upright with respect to the inner surface 27A1 of the cleaning frame 27.

In the embodiment, the positioning hole 8C and the positioning boss 27f are disposed only on the one end (front end portion) in the longitudinal direction of the cleaning unit 26. However, the positioning hole 8C and the positioning boss 27f need not be disposed on the one end (front end portion), and may be disposed only on the other end (rear end portion).

Next, a state of the abutment portion 8a of the cleaning member 6 and the support portion 27b of the cleaning frame 27 at the time when the process cartridge 70 drops, for example, in a direction (direction indicated by an arrow D in FIG. 3) perpendicular to the direction of the rotation axis of the photosensitive drum 1 will be described.

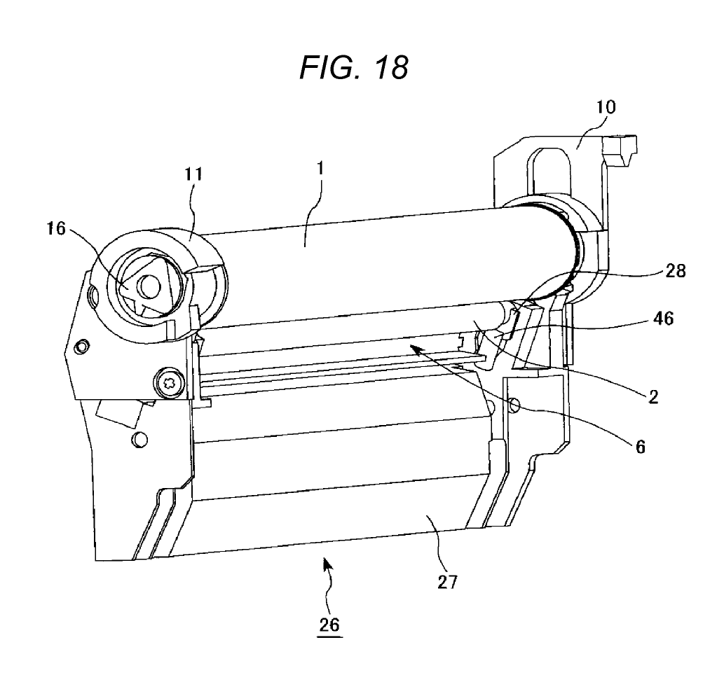

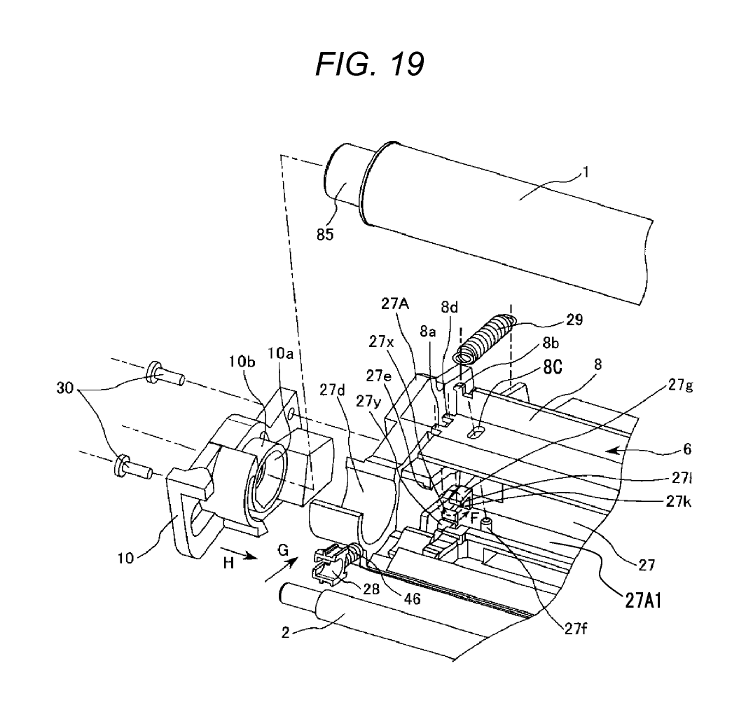

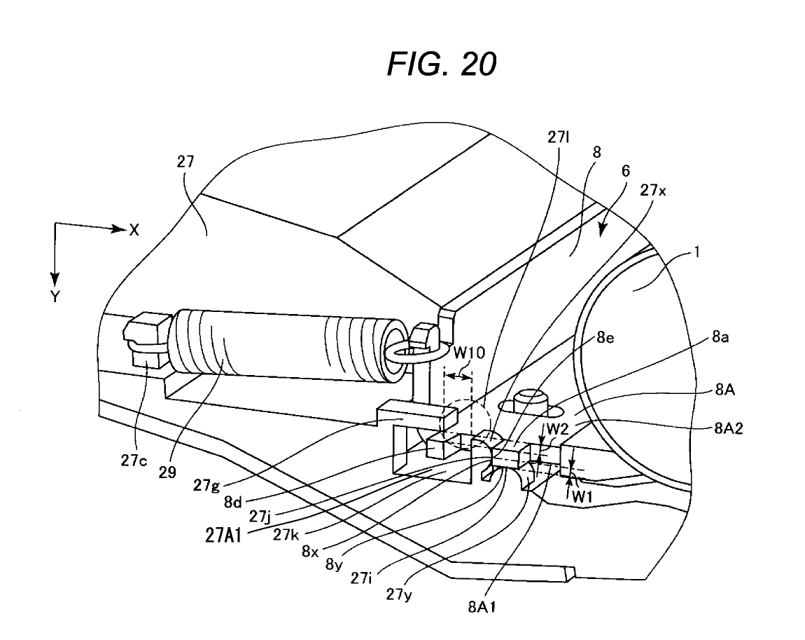

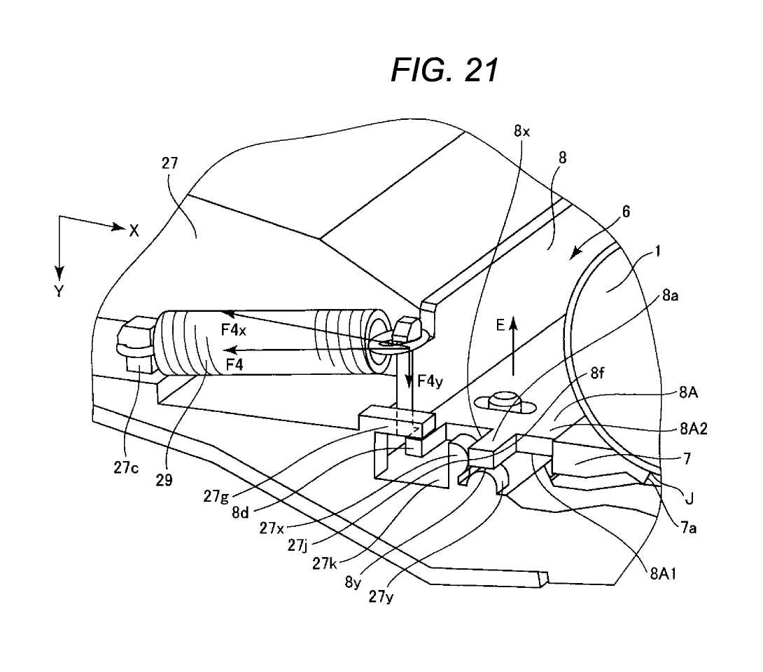

FIG. 18 is a perspective view of the cleaning unit 26 from which the developing unit 4 is removed. FIG. 19 is an exploded perspective view of the cleaning unit 26 as viewed from the drum front bearing 10. FIG. 20 is a partial sectional view illustrating a positional relationship between the cleaning member 6 and the cleaning frame 27 in the state in which the process cartridge 70 is maintained in a stationary state and rotation of the photosensitive drum 1 is stopped. Further, FIG. 21 is a partial sectional view illustrating a positional relationship between the cleaning member 6 and the cleaning frame 27 at the time of, for example, drop of the process cartridge 70.

As illustrated in FIG. 17, at the one end portion in the longitudinal direction of the main part 8A of the support member 8 for the cleaning member 6, a projecting portion (projection shape) 8d as a regulated portion disposed opposite to a regulating portion 27g described below is projected. In the embodiment, the projecting portion 8d is formed into a substantially rectangular parallelepiped shape of which one side surface is continuous with the side surface of the end portion in the longitudinal direction of the main part 8A of the support member 8. One side surface among side surfaces of the projecting portion 8d, which is flush with the second side surface 8A2 of the main part 8A of the support member 8, is opposite to and comes into contact with the regulating portion 27g described below. Further, in the embodiment, the projecting portion 8d is provided adjacent to the bent part 8D of the main part 8A of the support member 8.

Meanwhile, at the one end portion in the longitudinal direction of the cleaning frame 27 (specifically, in the embodiment, cleaning frame main body 27A), the regulating portion 27g is provided in a position opposite to the projecting portion 8d of the cleaning member 6 at a predetermined clearance (in the −Y direction with respect to the projecting portion 8d). In other words, in the embodiment, the regulating portion 27g is provided on the cleaning frame 27 (specifically, cleaning frame main body 27A) so as to be opposite to the projecting portion 8d of the cleaning member 6 from the side of the photosensitive drum 1 with the predetermined clearance between the regulating portion 27g and the projecting portion 8d.

When the process cartridge 70 is subject to an impact due to a falling of the process cartridge 70, the regulating portion 27g regulates the first abutment portion 8y and the second abutment portion 8x from being displaced with respect to the first support portion 27y and the second support portion 27x(in the −Y direction), respectively, to thereby regulate the abutment portion 8a from being disengaged from the support portion 27b. Then, with the urging force of the tension spring 29, the position of the first abutment portion 8y with respect to the first support portion 27y and the position of the second abutment portion 8x with respect to the second support portion 27x are returned to the original positions at which the process cartridge 70 is maintained in a stationary state and rotation of the photosensitive drum 1 is stopped. This mechanism will be described in detail below.

Note that, in the embodiment, in the lateral direction of the main part 8A of the support member 8, the abutment portion 8a is disposed on the support member 8 on the side of the rubber blade 7, and the projecting portion 8d is disposed on the support member 8 on the side of the bent part 8D. However, in the arrangement in the lateral direction of the main part 8A of the support member 8, the abutment portion 8a and the projecting portion 8d may be changed round.

FIG. 20 illustrates a state in which the process cartridge 70 is maintained in a stationary state and rotation of the photosensitive drum 1 is stopped. The apex (a contact position between the first abutment portion 8y and the first support portion 27y) of the outer peripheral surface of the circular-arc shape in cross-section of the first support portion 27y in this state is defined as a first apex 27i. Further, the apex (a contact position between the second abutment portion 8x and the second support portion 27x) of the outer peripheral surface of the circular-arc shape in cross-section of the second support portion 27x in the same state is defined as a second apex 27j. In addition, the first apex 27i and the second apex 27j are separated from each other by a distance W1 in a direction in which the first abutment portion 8y is moved away from the first support portion 27y (substantially in −Y direction). Similarly, in this state, the projecting portion 8d and the regulating portion 27g opposing to the projecting portion 8d are separated from each other (substantially in the −Y direction) by a distance W2. In other words, the regulating portion 27g is arranged at a position spaced apart from the projecting portion 8d by the distance W2 (>0). With this, without hindering a pivot of the cleaning member 6 about the abutment portion 8a as a pivot axis, movement of the projecting portion 8d can be regulated with the regulating portion 27g. The distance W1 and the distance W2 have a relationship of W1≧W2. This setting will be described in detail below.

As illustrated in FIG. 21, when a drop impact or the like is exerted on the process cartridge 70, the following may occur. Specifically, the cleaning member 6 may be rotated about a fulcrum or a contact position J between the tip portion 7a of the rubber blade 7 and the photosensitive drum 1 in a direction (a direction indicated by an arrow E in FIG. 21) in which the first abutment portion 8y of the support member 8 is moved away from the first support portion 27y of the cleaning frame 27.

At this time, the projecting portion 8d of the support member 8 comes into contact with the regulating portion 27g of the cleaning frame 27 so as to regulate the rotation in the above-mentioned direction. A contact position of the second abutment portion 8x with the second support portion 27x at this time is defined as a displacement contact position 8f. Further, a contact position of the second abutment portion 8x with the second support portion 27x in the state in which the process cartridge 70 is maintained in a stationary state and rotation of the photosensitive drum 1 is stopped is defined as a stationary contact position 8e (FIG. 20). In this case, the displacement contact position 8f substantially corresponds to a position moved in the Y direction from the stationary contact position 8e by the distance W2. As described above, the relationship of W1≧W2 is established (FIG. 20). In other words, the moving distance W2 at the time of application of the above-mentioned impact and the maximum moving distance W1 which allows the second abutment portion 8x in contact with the second support portion 27x have a relationship of W1=W2 or W1>W2.

Thus, the abutment portion 8a of the support member 8 is not disengaged from the second support portion 27x. Further, the regulating portion 27g is positioned in the distance relationships as described above, and hence, after the movement by the distance W2, an urging force F4y in the Y direction of the tension spring 29 causes the abutment portion 8a of the support member 8 to return to the original position at which the process cartridge 70 is maintained in a stationary state and rotation of the photosensitive drum 1 is stopped. In this way, the above-mentioned distance relationship of W1≧W2 is satisfied, and hence the position of the cleaning member 6 is stabilized even when the drop impact or the like of the process cartridge 70 is applied.

In this way, the cleaning frame 27 has the regulating portion 27g configured to regulate the abutment portion 8a from being moved in the direction in which the first abutment portion 8y is moved away from the first support portion 27y. The regulating portion 27g opposes to the projecting portion 8d of the cleaning member 6 from the side of the photosensitive drum 1 with the predetermined clearance between the regulating portion 27g and the projecting portion 8d while allowing the cleaning member 6 to pivot about the abutment portion 8a as a pivot axis. More specifically, a distance in the separation direction from the contact position between the first abutment portion 8y and the first support portion 27y to the contact position between the second abutment portion 8x and the second support portion 27x is equal to or longer than the predetermined clearance. It is desired that the regulating portion 27g include regulating portions 27g provided at at least two points in the direction along the direction of the rotation axis of the photosensitive drum 1. With this, the position of the cleaning member 6 can be further stabilized during transportation or the like. In the embodiment, the regulating portion 27g is provided to each of both the end portions of the cleaning member 6 in the direction along the direction of the rotation axis of the photosensitive drum 1. Note that, when desired, the regulating portion 27g may be provided only one point in the direction along the direction of the rotation axis of the photosensitive drum 1, such as one of both the end portions of the cleaning member 6 in the direction along the direction of the rotation axis of the photosensitive drum 1.

Next, a procedure for assembling the cleaning unit 26 according to the embodiment will be described.

As illustrated in FIG. 19, first, the projecting portion 8d is temporarily set to a temporal receiving portion 27k in a manner that the projecting portion 8d of the support member 8 is inserted through an opening portion 27l of the temporal receiving portion 27k of the cleaning frame 27 (direction indicated by an arrow F in FIG. 19). The temporal receiving portion 27k is formed on the inner surface 27A1 of the cleaning frame 27 so as to be opposed to the regulating portion 27g, and the opening portion 27l is formed of a clearance between the support portion 27b and a distal end of the regulating portion 27g on the side of the support portion 27b (FIG. 20). A dimension of a distance W10 (X direction) between the distal end of the regulating portion 27g and the support portion 27b in the opening portion 27l of the temporal receiving portion 27k is set to be larger than a dimension in the X direction of the projecting portion 8d so as to allow the projecting portion 8d to pass through the opening portion 27l.

Then, the abutment portion 8a of the support member 8 is brought into abutment with the support portion 27b of the cleaning frame 27. Simultaneously, the first abutment portion 8y and the second abutment portion 8x of the support member 8 come into contact with the first support portion 27y and the second support portion 27x of the cleaning frame 27, respectively. In this way, the support member 8 is roughly positioned with respect to the cleaning frame 27. Further, at this time, as illustrated in FIG. 17, the positioning hole 8C of the cleaning member 6 and the positioning boss 27f of the cleaning frame 27 are engaged with each other. As described above, the positioning hole 8C is an elongate hole elongated in the lateral direction (X direction) of the main part 8A of the support member 8, and clearances are formed between rim portions in the X direction of the positioning hole 8C and the positioning boss 27f. Meanwhile, in the longitudinal direction of the cleaning member 6, the positioning hole 8C and the positioning boss 27f are configured to have a fitting relationship. With this, without hindering a pivot of the cleaning member 6 about the abutment portion 8a as a pivot axis, the cleaning member 6 can be positioned in the longitudinal direction with respect to the cleaning frame 27.

Next, as illustrated in FIG. 19, the charging roller bearing 28 and the charging roller pressure member 46 are mounted to the receiving portion 27e of the cleaning frame 27 in a direction indicated by an arrow G in FIG. 19. Then, the charging roller 2 is mounted to the charging roller bearing 28 in the direction indicated by the arrow G in FIG. 19. In this way, the charging roller 2 is attached to the cleaning frame 27.

Next, as illustrated in FIG. 19, the flange 85 of the photosensitive drum 1 is temporarily set to the drum positioning portion 27d provided to the cleaning frame 27. The drum positioning portion 27d has the inner diameter dimension larger than the outer diameter dimension of the flange 85 of the photosensitive drum 1. Thus, the photosensitive drum 1 can be temporarily positioned to the cleaning frame 27.

Next, as indicated by an arrow H in FIG. 19, the drum front bearing 10 is mounted to the cleaning frame 27 in the direction of the rotation axis of the photosensitive drum 1. The drum front bearing 10 includes the rotary shaft support portion 10a for the photosensitive drum 1. With this, when the drum front bearing 10 is attached to the cleaning frame 27, the photosensitive drum 1 and the rotary shaft support portion 10a are positioned relative to each other. The bearing positioning portion 10b of the drum front bearing 10 and the drum positioning portion 27d of the cleaning frame 27 are each formed to have dimensions so as to be fitted to each other. Through engagement of those portions, the drum front bearing 10 is positioned with respect to the cleaning frame 27. Further, the drum front bearing 10 and the cleaning frame 27 respectively include positioning units (not shown) configured to position the drum front bearing 10 and the cleaning frame relative to each other in the sectional direction (rotational direction) substantially orthogonal to the direction of the rotation axis of the photosensitive drum 1. Through engagement of those units, the drum front bearing and the cleaning frame 27 are positioned relative to each other in the sectional direction.

In this state, the drum front bearing 10 and the cleaning frame 27 are fixed to each other with the fixing units such as the screws 30. With this, the assembly of the drum front bearing 10 to the cleaning frame 27 is completed.

Lastly, as illustrated in FIG. 19, the tension spring 29 is stretched between the attaching portion 8b of the cleaning member 6 and the boss 27c of the cleaning frame 27.

The procedure for assembling the cleaning unit 26 will be described with a focus only on the one end portion (front end portion) in the longitudinal direction of the cleaning unit 26. However, the same procedure as above is synchronously performed also on the other end portion (rear end portion) of the cleaning unit 26. Note that, at the other end portion (rear end portion) of the cleaning unit 26, the drum rear bearing 11 is attached to the cleaning frame 27 by the same method as above. Further, in the embodiment, as described above, at the other end portion (rear end portion) of the cleaning unit 26, the positioning hole 8C of the cleaning member 6 and the positioning boss 27f of the cleaning frame 27 are not provided.

With this, assembly of the cleaning unit 26 is completed, and the cleaning member 6 abuts against the photosensitive drum 1 by a predetermined pressure. In this way, preparation of cleaning is completed.

As described above, according to the embodiment, even when the abutment portion 8a of the cleaning member 6 is displaced with respect to the support portion 27b of the cleaning frame 27 during transportation or the like, the cleaning member 6 is regulated by the regulating portion 27g, and returned to the original position by the urging force of the tension spring 29. In this way, the position of the cleaning member 6 is stabilized.

### Third Embodiment

Next, still another embodiment of the present invention will be described. The basic structures of a cleaning unit, a process cartridge, and an image forming apparatus according to the embodiment are the same as those of the second embodiment. Therefore, in the embodiment, components having the same functions and configurations as those of the second embodiment or having the functions and configurations corresponding thereto are denoted by the same reference symbols, and detailed description thereof is omitted.

In the embodiment, as in the second embodiment, another example of the configuration of stabilizing the position of the cleaning member 6 during transportation or the like will be described.

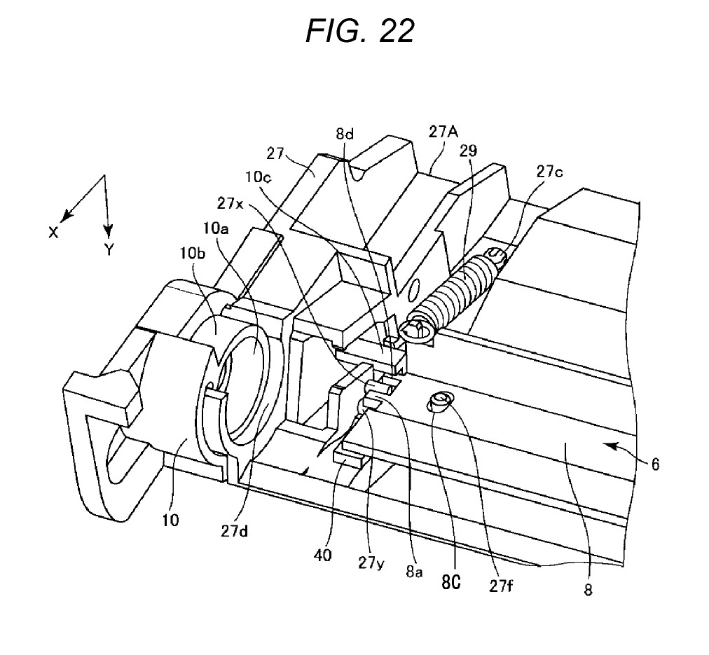

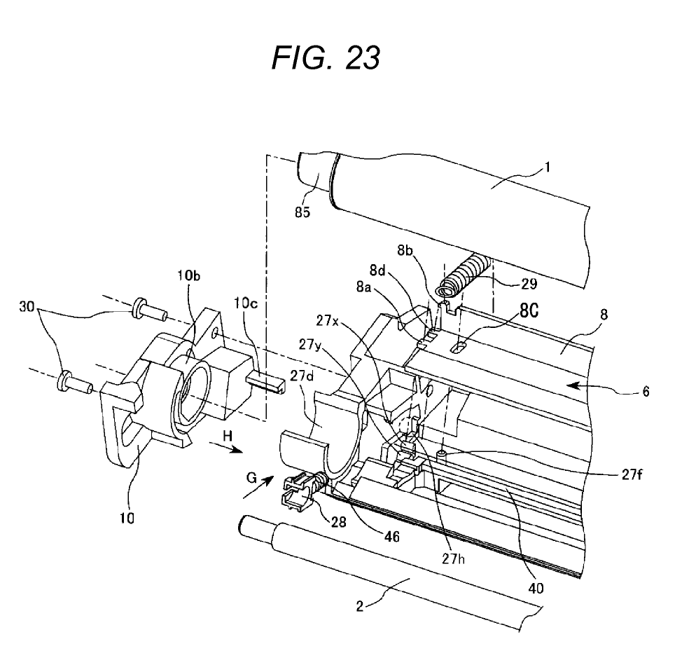

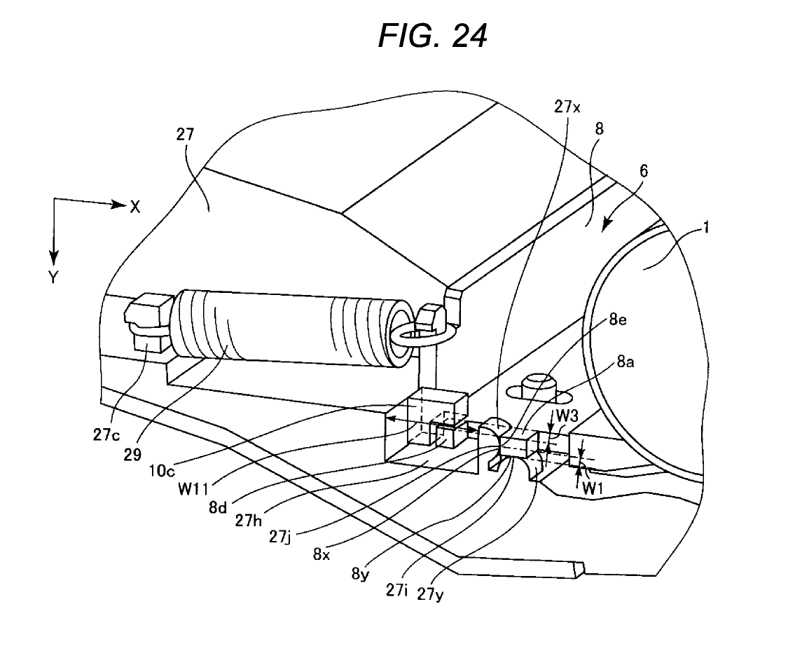

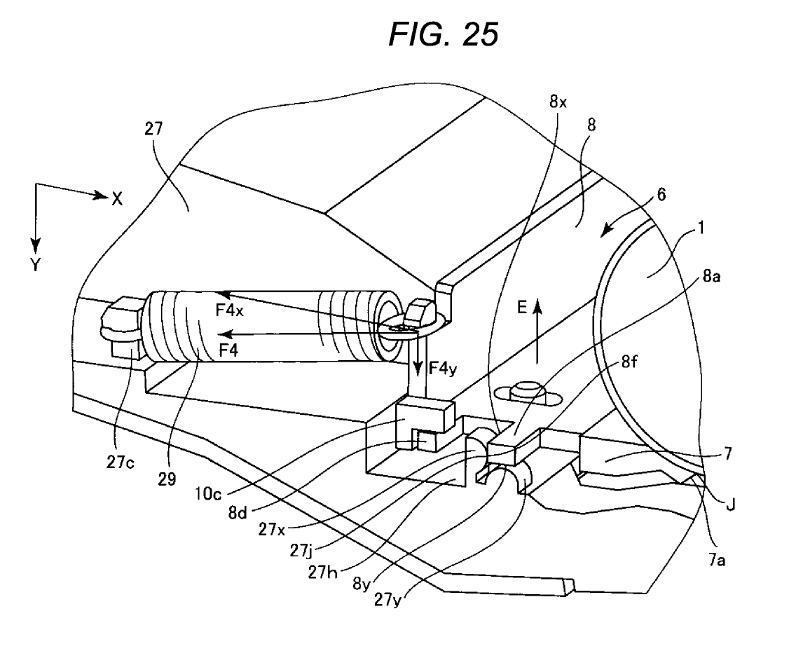

FIG. 22 is an exploded perspective view of the cleaning unit 26 as viewed from the side of the drum front bearing 10, from which the photosensitive drum 1, the charging roller 2, and the like are removed. FIG. 23 is an exploded perspective view of the cleaning unit 26 as viewed from the side of the drum front bearing 10. FIG. 24 is a partial sectional view illustrating a positional relationship between the cleaning member 6 and the cleaning frame 27 in the state in which the process cartridge 70 is maintained in a stationary state and rotation of the photosensitive drum 1 is stopped. Further, FIG. 25 is another partial sectional view illustrating a positional relationship between the cleaning member 6 and the cleaning frame 27 at the time of, for example, falling of the process cartridge 70.

As illustrated in FIG. 22, in the embodiment, a regulating portion 10c is provided at an end portion (end portion on the side of the cleaning frame main body 27A) of the drum front bearing 10 in the direction of the rotation axis of the photosensitive drum 1. The regulating portion 10c is provided in a position (−Y direction with respect to the projecting portion 8d) which is opposed to the projecting portion 8d of the cleaning member 6 with a predetermined clearance between the regulating portion 10c and the projecting portion 8d. In other words, in the embodiment, the regulating portion 10c is provided on the drum front bearing 10 forming the cleaning frame 27 cooperatively with the cleaning frame main body 27A so as to be opposed to the projecting portion 8d of the cleaning member 6 from the side of the photosensitive drum 1 with the predetermined clearance between the regulating portion 10c and the projecting portion 8d.

As illustrated in FIG. 24, as in the second embodiment, the first apex 27i and the second apex 27j are separated from each other by the distance W1 in the direction (substantially in −Y direction) in which the first abutment portion 8y is moved away from the first support portion 27y. Further, a distance W3 is secured between the projecting portion 8d and the regulating portion 10c opposed to the projecting portion 8d (substantially in the −Y direction) in the state in which the process cartridge 70 is maintained in a stationary state and rotation of the photosensitive drum 1 is stopped. In other words, the regulating portion 10c is disposed in a position spaced apart from the projecting portion 8d by the distance W3 (>0). With this, without hindering a pivot of the cleaning member 6 about the abutment portion 8a as a pivot axis, movement of the projecting portion 8d can be regulated with the regulating portion 10c. The distance W1 and the distance W3 have a relationship of W1≧W3. This setting will be described in detail below.

As illustrated in FIG. 25, when a drop impact or the like is exerted on the process cartridge 70, the following may occur. Specifically, the cleaning member 6 may be rotated about a fulcrum or the contact position J between the tip portion 7a of the rubber blade 7 and the photosensitive drum 1 in the direction (direction indicated by an arrow E in FIG. 25) in which the first abutment portion 8y of the support member 8 is moved away from the first support portion 27y of the cleaning frame 27.

At this time, the projecting portion 8d of the support member 8 comes into contact with the regulating portion 10c of the drum front bearing 10 so as to regulate the rotation in the above-mentioned direction. A contact position of the second abutment portion 8x with the second support portion 27x at this time is defined as a displacement contact position 8f. Further, a contact position of the second abutment portion 8x with the second support portion 27x in the state in which the process cartridge 70 is maintained in a stationary state and rotation of the photosensitive drum 1 is stopped is defined as the stationary contact position 8e (FIG. 24). In this case, the displacement contact position 8f substantially corresponds to a position moved in the Y direction from the stationary contact position 8e by the distance W3. As described above, the relationship of W1≧W3 is established (FIG. 24). In other words, the moving distance W3 at the time when the process cartridge 70 is subject to the above-mentioned impact and the maximum moving distance W1 which allows the second abutment portion 8x in contact with the second support portion 27x have a relationship of W1=W3 or W1>W3.

Thus, the abutment portion 8a of the support member 8 is not disengaged from the second support portion 27x. Further, the regulating portion 10c is positioned in the distance relationships as described above, and hence, after the movement by the distance W3, the urging force F4y in the Y direction of the tension spring 29 causes the abutment portion 8a of the support member 8 to return to the original position in which the process cartridge 70 is maintained in a stationary state and rotation of the photosensitive drum 1 is stopped. In this way, the above-mentioned relationship of W1≧W3 is satisfied, and hence the position of the cleaning member 6 is stabilized even when the drop impact or the like is exerted on the process cartridge 70.

Next, a procedure for assembling the cleaning unit 26 according to the embodiment will be described.

As illustrated in FIG. 23, first, the abutment portion 8a of the support member 8 is brought into abutment with the support portion 27b of the cleaning frame 27. Simultaneously, the first abutment portion 8y and the second abutment portion 8x of the support member 8 come into contact respectively with the first support portion 27y and the second support portion 27x of the cleaning frame 27. In this way, the support member 8 is roughly positioned with respect to the cleaning frame 27.

After that, by the same procedure as that in the second embodiment, the following are performed: positioning the cleaning member 6 in the longitudinal direction thereof; assembling the charging roller 2 to the cleaning frame 27; and assembling the photosensitive drum 1 and the drum front bearing 10 to the cleaning frame 27.

When the drum front bearing 10 is fixed to the cleaning frame 27, the regulating portion 10c of the drum front bearing 10 is inserted into an opening portion 27h provided to the cleaning frame 27. As illustrated in FIG. 24, a dimension of a distance W11 (X direction) of the opening portion 27h is set to be larger than a dimension in the X direction of the regulating portion 10c so as to allow the regulating portion 10c of the drum front bearing 10 to be inserted.

In this state, the drum front bearing 10 and the cleaning frame 27 are fixed to each other with the fixing units such as the screws 30. With this, the assembly of the drum front bearing 10 to the cleaning frame 27 is completed.

Lastly, as illustrated in FIG. 24, the tension spring 29 is stretched between the attaching portion 8b of the cleaning member 6 and the boss 27c of the cleaning frame 27.

The procedure for assembling the cleaning unit 26 will be described with a focus only on the one end portion (front end portion) in the longitudinal direction of the cleaning unit 26. However, the same procedure is synchronously performed also on the other end portion (rear end portion) of the cleaning unit 26. Note that, at the other end portion (rear end portion) of the cleaning unit 26, the drum rear bearing 11 is mounted to the cleaning frame 27 by the same method described above. Further, in the embodiment, as described above, at the other end portion (rear end portion) of the cleaning unit 26, the positioning hole 8C of the cleaning member 6 and the positioning boss 27f of the cleaning frame 27 are not provided.

With this, assembly of the cleaning unit 26 is completed, and the cleaning member 6 abuts against the photosensitive drum 1 by a predetermined pressure. In this way, preparation of cleaning is completed. Further, in this state, the regulating portion 10c of the drum front bearing 10 and the projecting portion 8d of the support member 8 are spaced apart from each other by the distance W3.

As described above, according to the embodiment, with the regulating portion 10c provided on the drum front bearing 10, the position of the cleaning member 6 can be stabilized during transportation or the like as in the second embodiment. In addition, assembly efficiency of can be further enhanced.

### Fourth Embodiment

Next, yet another embodiment of the present invention will be described. The basic structures of a cleaning unit, a process cartridge, and an image forming apparatus according to the embodiment are the same as those of the first embodiment. Therefore, in the embodiment, components having the same functions and configurations as those of the first embodiment or having the functions and configurations corresponding thereto are denoted by the same reference symbols, and detailed description thereof is omitted.

In the embodiment, another example of the configuration of suppressing the displacement in the longitudinal direction of the cleaning member 6 will be described.

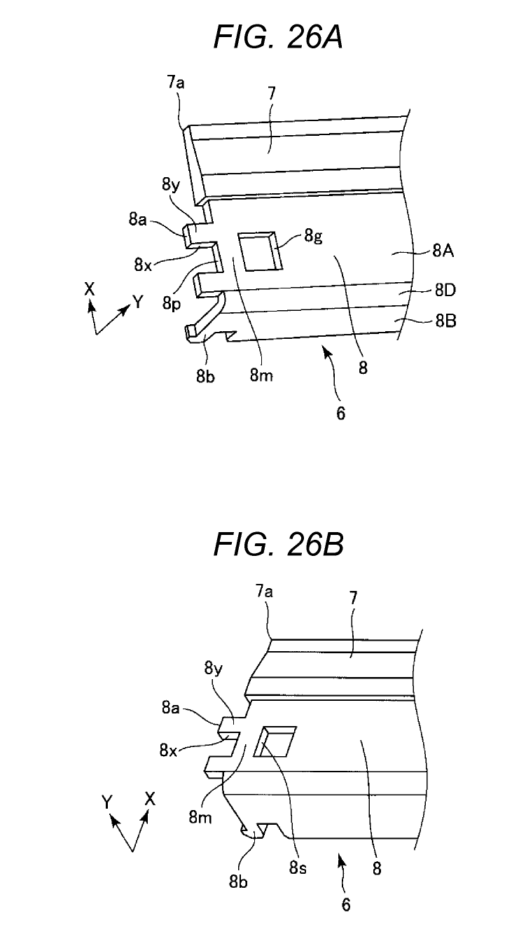

As illustrated in FIGS. 26A and 26B, in the embodiment, the cleaning member 6 is provided with a positioned portion 8m configured to position the cleaning member 6 in the longitudinal direction thereof with respect to the cleaning frame 27. In the embodiment, the positioned portion 8m is formed of a through-hole 8g provided near the end portion in the longitudinal direction of the main part 8A of the support member 8. In other words, the positioned portion 8m is a columnar portion including a side surface of the end portion in the longitudinal direction of the main part 8A of the support member 8 and an inner side surface of the through-hole 8g, and extending in the direction substantially orthogonal to the longitudinal direction of the main part 8A.

The positioned portion 8m has a first positioned surface 8p adjacent to the second abutment portion 8x of the abutment portion 8a and a second positioned surface 8s located opposite to the first positioned surface 8p. In the positioned portion 8m, the first positioned surface 8p is formed of the side surface of the end portion in the longitudinal direction of the main part 8A, and extends in the direction (in other word, lateral direction) substantially orthogonal to the longitudinal direction of the main part 8A. In the positioned portion 8m, the second positioned surface 8s is formed of the inner side surface of the through-hole 8g, and extends in the direction (in other words, lateral direction) substantially orthogonal to the longitudinal direction of the main part 8A.

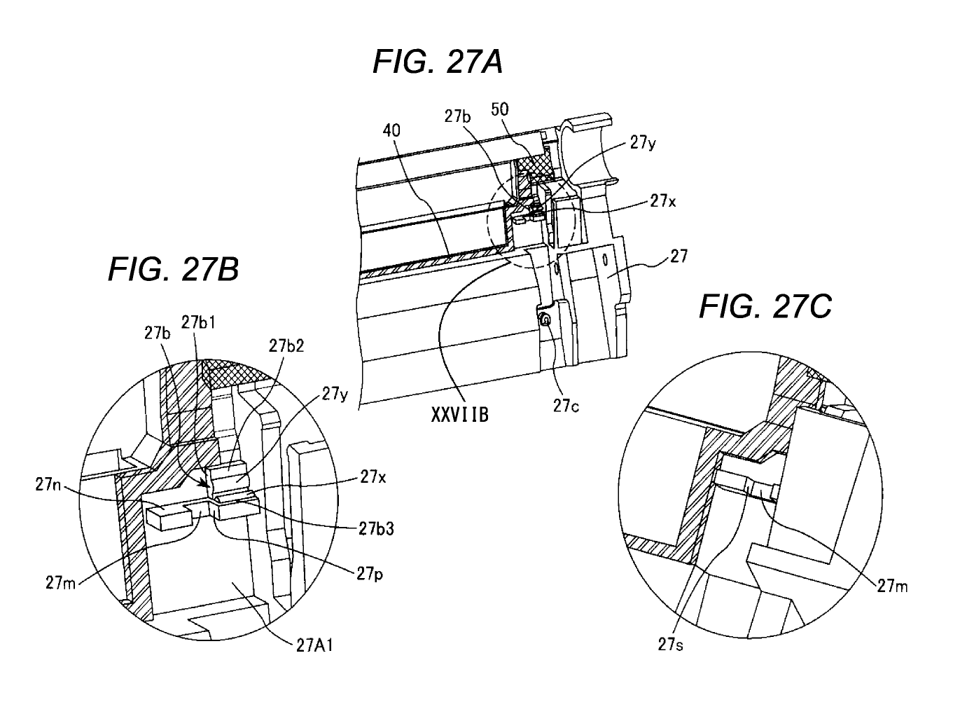

Further, in the embodiment, as illustrated in FIGS. 27A, 27B, and 27C, the cleaning frame 27 includes a positioning portion 27m configured to position the cleaning member 6 in the longitudinal direction thereof with respect to the cleaning frame 27. The positioning portion 27m has a first positioning surface 27p which comes into contact with the first positioned surface 8p, and a second positioning surface 27s which is opposed to the first positioning surface 27p and comes into contact with the second positioned surface 8s. The first positioning surface 27p and the second positioning surface 27s each extend in the −Y direction from the inner surface 27A1 of the cleaning frame 27.

In further detail, in the embodiment, as in the first embodiment, the support portion 27b of the cleaning frame 27 is formed on the rack portion 27b1 which has a substantial L-shape in cross-section as viewed in the direction of the rotation axis of the photosensitive drum 1 and is projected from the inner surface 27A1 of the cleaning frame 27. In the embodiment, the first positioning surface 27p is formed of a side surface of the horizontal rack portion 27b3 on the side of the support member 8 along the −Y direction of the rack portion 27b1. Further, in the embodiment, in a position opposed to the horizontal rack portion 27b3 of the support portion 27b in the direction of the rotation axis of the photosensitive drum 1, a protruding portion 27n having the same shape as that of horizontal rack portion 27b3 is projected from the inner surface 27A1 of the cleaning frame 27. The protruding portion 27n is inserted into the through-hole 8g. In the embodiment, the second positioning surface 27s is formed of a side surface of the protruding portion 27n on the side of an end portion thereof in the direction of the rotation axis of the photosensitive drum 1.

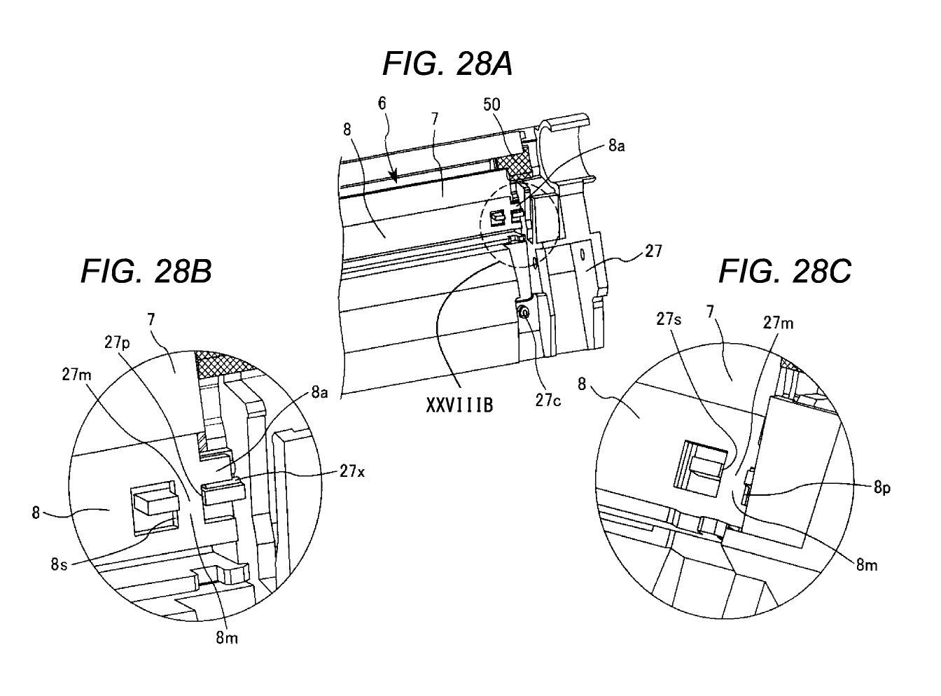

As illustrated in FIGS. 28A, 28B, and 28C, the positioned portion 8m of the cleaning member 6 is engaged with the positioning portion 27m of the cleaning frame 27. With this, while allowing the cleaning member 6 to pivot about the abutment portion 8a as a pivot axis, the cleaning member 6 can be positioned in the longitudinal direction thereof with respect to the cleaning frame 27.

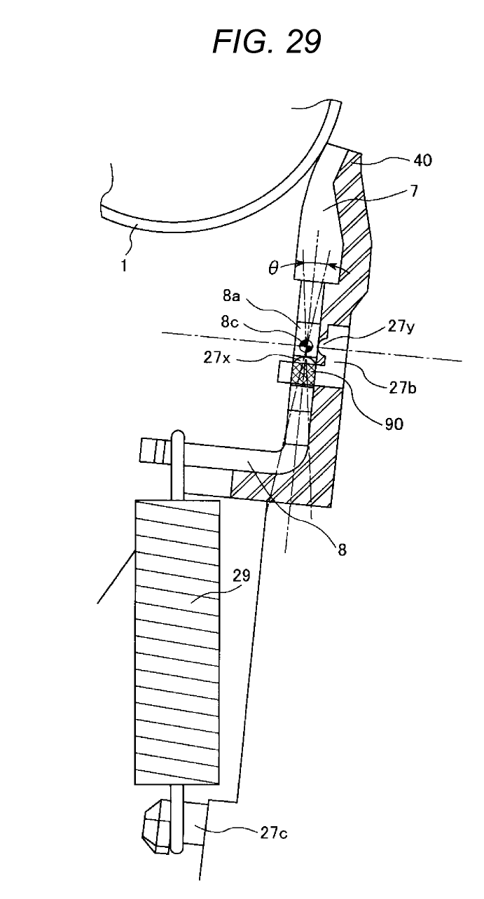

Further, in a positioning region 90 indicated by hatching in FIG. 29, the first positioned surface 8p and the second positioned surface 8s are in contact with the first positioning surface 27p and the second positioning surface 27s, respectively, so as to position the cleaning member 6 in the longitudinal direction thereof.

As described above, in the embodiment, the first positioned surface 8p is a surface adjacent to the second abutment portion 8x, and the positioning region 90 is located near the pivot center 8c of the cleaning member 6. With this, when the cleaning member 6 pivots within a pivotable range θ, an amount of sliding between the first positioned surface 8p and the first positioning surface 27p and an amount of sliding between the second positioned surface 8s and the second positioning surface 27s can be suppressed. Thus, grinding of the first positioned surface 8p and the first positioning surface 27p, and grinding of the second positioned surface 8s and the second positioning surface 27s can be suppressed.

As described above in the embodiment, the structure of positioning the cleaning member 6 in the longitudinal direction thereof with respect to the cleaning frame 27 is provided at one point on the side of the one end portion (front end portion) in the direction of the rotation axis of the photosensitive drum 1.

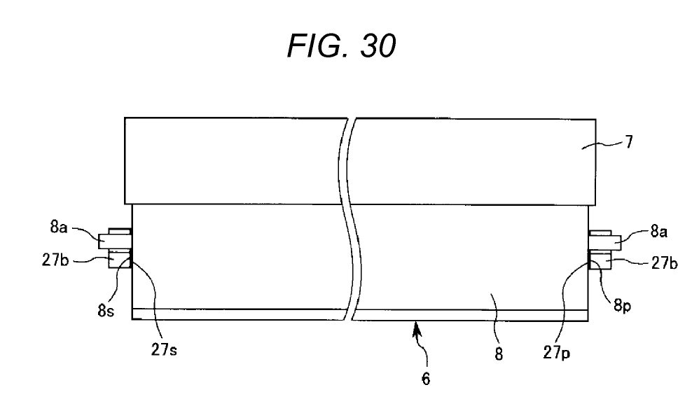

Note that, as illustrated in FIG. 30, the other side surface of the support member 8 and the other side surface of the support portion 27b on the other end portion on the other side, which is opposite to the side on which the first positioned surface 8p and the first positioning surface 27p in the embodiment are provided, in the longitudinal direction of the cleaning member 6 may be utilized as the second positioned surface 8s and the second positioning surface 27s, respectively. Also in this case, the second positioned surface 8s, which is a side surface of the support member 8 on the other end portion on the opposite side, is located opposite to the first positioned surface 8p.

As described above, according to the embodiment, one of the positioned surfaces configured to position the cleaning member 6 in the longitudinal direction thereof is provided adjacent to a supported surface (specifically, second abutment portion 8x) of the cleaning member 6. In particular, in the embodiment, one side surface of the support portion 27b of the cleaning frame 27 is used as the positioning surface which is engaged with the one of the positioned surfaces of the cleaning member 6. With this, abrasions of the cleaning frame 27 and the cleaning member 6 caused by the pivotal movement of the cleaning member 6 can be suppressed.

### Other Embodiment

The present invention is specifically described by way of embodiments. However, the present invention is not limited by the embodiments described above.

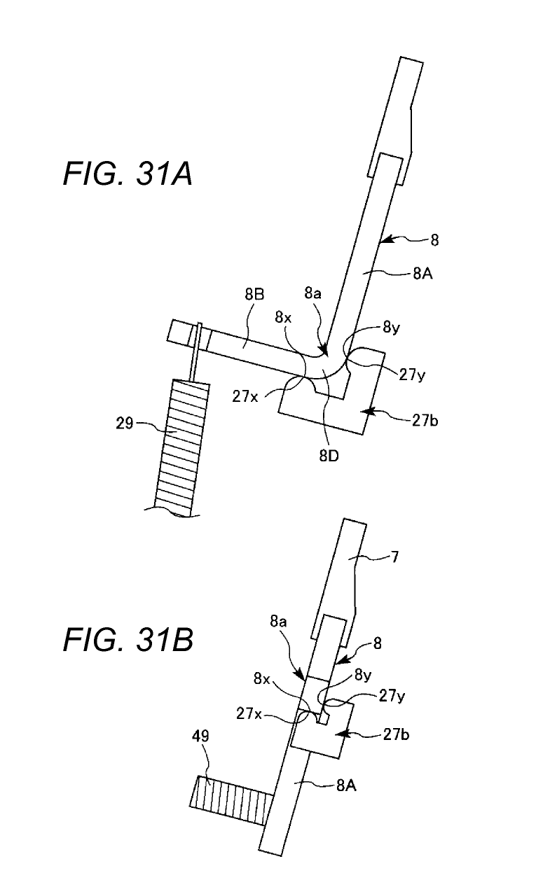

In the embodiments described above, the abutment portion 8a is projected from the end portion in the longitudinal direction of the main part 8A of the support member 8. However, the present invention is not limited thereto. For example, as illustrated in FIG. 31A, at each of both the end portions in the longitudinal direction of the support member 8, a side surface of the main part 8A and a side surface of the strengthening part 8B, which are each adjacent to the bent part 8D of the support member 8, may be used as they are as the first abutment portion 8y and the second abutment portion 8x, respectively. Note that, the strengthening part 8B, which is bent with respect to the main part 8A, needs not be formed over the entire length of the support member 8 in the longitudinal direction. The strengthening part may be formed only at each of both the end portions of the support member 8 in the longitudinal direction.

Further, in the embodiments described above, the support member 8 includes the main part 8A and the strengthening part 8B bent at the bent part 8D with respect to the main part 8A. However, the present invention is not limited thereto. For example, as illustrated in FIG. 31B, the support member 8 may include only a part corresponding to the main part 8A in the embodiments described above, and the abutment portion 8a similar to that in the embodiments described above may be provided at an edge portion along a longitudinal direction of that part. Further, in the embodiments described above, the tension spring is used as the urging member. However, for example, in a case of using the support member 8 illustrated in FIG. 31B, a compression spring 49 may be used as the urging member. In this case, the compression spring 49 is arranged between the receiving portion 27e provided to the cleaning frame 27 and the acting portion of the support member 8, which is urged by the urging member. With this, the support member 8 can be urged in a direction in which the rubber blade 7 is brought into abutment with the photosensitive drum 1, to thereby pivot the support member 8 about the abutment portion 8a as a pivot axis.

According to the embodiments, the cleaning member can be supported in a pivotable manner with a simple structure such as the frame without use of the separate member such as the pin, to thereby achieve reduction in manufacturing cost and to enable easier assembly.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-101857, filed Apr. 26, 2012, which is hereby incorporated by reference herein in its entirety.

What is claimed is:

1. A cleaning unit, comprising:
a rotatable photosensitive drum;
a cleaning member configured to remove toner from the photosensitive drum; and
a frame configured to support the photosensitive drum and the cleaning member,
wherein the cleaning member includes:
an elastic member which abuts against the photosensitive drum; and
a support member configured to support the elastic member,
wherein the support member has frame abutment portions which abut against the frame at both end portions of the support member in a direction along a direction of a rotation axis of the photosensitive drum, respectively,
wherein each of the frame abutment portions has:
a first abutment portion formed by a surface extending in one direction; and
a second abutment portion formed by a surface extending in another direction intersecting with the one direction,
the first abutment portion being directed to a side opposite to a side of the photosensitive drum with respect to a first axis extending from a corresponding one of the frame abutment portions to the elastic member as viewed in the direction of the rotation axis of the photosensitive drum,
the second abutment portion being directed to a side opposite to a side of the elastic member with respect to a second axis substantially orthogonal to the first axis,
wherein the frame includes cleaning member support portions which abut against the frame abutment portions at both the end portions of the support member, respectively,
wherein each of the cleaning member support portions has:
a first support portion which abuts against the first abutment portion; and
a second support portion which abuts against the second abutment portion,
the cleaning member support portions supporting the cleaning member in a pivotable manner about the frame abutment portions as a pivot axis, and
wherein the cleaning unit further comprises an urging member configured to urge the cleaning member in a direction in which the elastic member is brought into contact with the photosensitive drum by pivoting the cleaning member about the frame abutment portions as the pivot axis.

2. A cleaning unit according to claim 1, wherein the support member comprises a plate-shaped main part extending substantially in parallel to the direction of the rotation axis of the photosensitive drum, and the frame abutment portions are projected from the plate-shaped main part at both end portions of the plate-shaped main part in the direction along the direction of the rotation axis of the photosensitive drum, respectively.

3. A cleaning unit according to claim 1, wherein the first abutment portion is flush with a surface of the plate-shaped main part on the side opposite to the side of the photosensitive drum with respect to the first axis.

4. A cleaning unit according to claim 1, wherein the support member comprises a sheet metal punched out through press working, the second abutment portion comprises a cut edge surface obtained through the press working, and the second support portion abuts against a shear surface zone of the cut edge surface.

5. A cleaning unit according to claim 1, wherein the first support portion and the second support portion are each formed into a circular-arc shape or a protruding shape having an apex in cross-section as viewed in the direction of the rotation axis of the photosensitive drum.

6. A cleaning unit according to claim 1, wherein, as viewed in the direction of the rotation axis of the photosensitive drum, a distance between an intersection point of a straight line extending along the second axis from a contact position between the first abutment portion and the first support portion and a straight line extending along the first axis from a contact position between the second abutment portion and the second support portion, and the contact position between the first abutment portion and the first support portion is substantially equal to a distance between the intersection point and the contact position between the second abutment portion and the second support portion.

7. A cleaning unit according to claim 1, wherein, as viewed in the direction of the rotation axis of the photosensitive drum, a distance between an intersection point of a straight line extending along the second axis from a contact position between the first abutment portion and the first support portion and a straight line extending along the first axis from a contact position between the second abutment portion and the second support portion, and a contact position between the elastic member and the photosensitive drum is substantially equal to a distance between the intersection point and an acting portion of the support member urged by the urging member.

8. A cleaning unit according to claim 1, wherein the frame comprises a regulating portion configured to regulate a movement of a corresponding one of the frame abutment portions in a direction in which the first abutment portion is moved away from the first support portion, and the regulating portion is opposed to a regulated portion of the cleaning member from the side of the photosensitive drum with a predetermined clearance between the regulating portion and the regulated portion while allowing the cleaning member to pivot about the frame abutment portions as the pivot axis.

9. A cleaning unit according to claim 8, wherein the regulating portion is provided in each of two or more points in the direction along the direction of the rotation axis of the photosensitive drum.

10. A cleaning unit according to claim 9, wherein the regulating portion is provided correspondingly to each of both end portions of the cleaning member in the direction along the direction of the rotation axis of the photosensitive drum.

11. A cleaning unit according to claim 8, wherein the support member comprises a plate-shaped main part extending substantially in parallel to the direction of the rotation axis of the photosensitive drum, and the regulated portion is projected from the plate-shaped main part at an end portion of the plate-shaped main part in the direction along the direction of the rotation axis of the photosensitive drum.

12. A cleaning unit according to claim 8, wherein, in the direction in which the first abutment portion is moved away from the first support portion, a distance between a contact position between the first abutment portion and the first support portion and a contact position between the second abutment portion and the second support portion is equal to or larger than the predetermined clearance.

13. A cleaning unit according to claim 8, wherein the frame is formed by coupling a first frame part provided with at least the cleaning member support portions to a second frame part configured to support the photosensitive drum in a rotatable manner, and the regulating portion is provided on the second frame part.

14. A cleaning unit according to claim 1, wherein the support member includes:
a first positioned surface which is formed of a side surface of one of the both end portions of the support member in the direction along the direction of the rotation axis of the photosensitive drum, the side surface being adjacent to a corresponding one of the frame abutment portions; and
a second positioned surface located opposite to the first positioned surface, and
wherein the frame comprises:
a first positioning surface which comes into contact with the first positioned surface so as to position the cleaning member in the direction of the rotation axis of the photosensitive drum; and
a second positioning surface which comes into contact with the second positioned surface so as to position the cleaning member in the direction of the rotation axis of the photosensitive drum.

15. A cleaning unit according to claim 14, wherein the support member comprises a plate-shaped main part extending substantially in parallel to the direction of the rotation axis of the photosensitive drum, and the frame abutment portions are projected from the plate-shaped main part at both end portions of the plate-shaped main part in the direction along the direction of the rotation axis of the photosensitive drum, respectively,
wherein the first positioned surface is formed of a side surface of a corresponding one of the both end portions of the plate-shaped main part in the direction along the direction of the rotation axis of the photosensitive drum, the side surface being adjacent to the second abutment portion, and
wherein the first positioning surface is formed of a side surface of a rack portion projected from an inner surface of the frame, the rack portion being provided with the second support portion.

16. A cleaning unit according to claim 15, wherein the second positioned surface is formed of an inner side surface of a hole formed in the plate-shaped main part, and
wherein the second positioning surface is formed of a side surface of a protruding portion which is projected from the inner surface of the frame and inserted into the hole.

17. A cleaning unit according to claim 16, wherein the first positioned surface, the second positioned surface, the first positioning surface, and the second positioning surface are provided at one point in the direction along the direction of the rotation axis of the photosensitive drum.

18. A process cartridge, comprising a cleaning unit according to claim 1, wherein the process cartridge is removably mounted to a main body of an electrophotographic image forming apparatus, and
wherein the electrophotographic image forming apparatus transfers a toner image, which is formed on the photosensitive drum of the cleaning unit, onto a recording material, fixes the toner image to the recording material, and outputs the recording material.

19. An electrophotographic image forming apparatus, comprising a process cartridge according to claim 18, wherein the process cartridge is removably mounted to a main body of the electrophotographic image forming apparatus, and
wherein the electrophotographic image forming apparatus transfers a toner image, which is formed on the photosensitive drum of the process cartridge, onto a recording material, fixes the toner image to the recording material, and outputs the recording material.
